(19) United States
(12) Patent Application Publication
(10) Pub. No.: US 2020/0402121 A1
(43) Pub. Date: Dec. 24, 2020

(54) COMPUTE RESOURCE EFFICIENT PERFORMANCE PRODUCT PROVISIONING

(71) Applicant: Starsona Inc., Mountain View, CA (US)

(72) Inventors: Peter Karpas, Los Altos, CA (US); Matthew Martin, San Jose, CA (US)

(73) Assignee: Starsona Inc., Mountain View, CA (US)

(21) Appl. No.: 16/979,160

(22) PCT Filed: Mar. 5, 2019
(86) PCT No.: PCT/US2019/020832

§ 371 Date: Sep. 8, 2020

Related U.S. Application Data
(60) Provisional application No. 62/638,629, filed on Mar. 5, 2018.

(51) Int. Cl. G06Q 30/02; G06Q 30/00; H04N 21/472; G06F 16/435

(52) U.S. Cl. CPC G06Q 30/0282; G06F 16/437; H04N 21/47217; G06Q 30/01

(57) ABSTRACT

Disclosed is a performance request for performance by a performer registered to a performance marketplace from a performance requester system associated with a performance requester, carrying out computer-based linguistic analysis of the performance request to identify detailed contents of the performance request to generate a formatted performance request including an instruction for proper pronunciation of a word, and forwarding the formatted performance request to a performer system associated with the performer. Also disclosed is receiving a performance product generated by the performer from the performer system, and transmitting the performance product to a performance receiver system associated with a performance receiver indicated by the performance request.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

In various implementations, a method includes receiving a performance request for performance by a performer registered to a performance marketplace from a performance requester system associated with a performance requester, carrying out computer-based linguistic analysis of the performance request to identify detailed contents of the performance request to generate a formatted performance request including an instruction for proper pronunciation of a word, and forwarding the formatted performance request to a performer system associated with the performer. The method further includes receiving a performance product generated by the performer from the performer system, and transmitting the performance product to a performance receiver system associated with a performance receiver indicated by the performance request.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a parameterized compute resource efficient, tailored-and-standards-compliant performance product marketplace.

FIG. 2 depicts a diagram of an example of a standards-compliant performer system for interacting with a performer in association with the generation of a standards-compliant performance product.

FIG. 3 depicts a diagram of an example of a performance product prosumer system for tailoring and requesting a tailored performance product.

FIG. 4 depicts a diagram of an example of a tailored performance product recipient system for playback of a multimedia portion of the tailored performance product.

FIG. 5 depicts a diagram of an example of a compute resource efficient performance product distribution system.

FIG. 6 depicts a flowchart of an example of a method for distributing a parameterized compute resource efficient, tailored-and-standards-compliant performance product.

FIG. 7 depicts a flowchart of an example of a method for managing a performer in a compute resource efficient performance product distribution system.

FIG. 8 depicts a flowchart of an example of a method for managing a prosumer in a compute resource efficient performance product distribution system.

FIG. 9 depicts a flowchart of an example of a method for managing a tailored performance product recipient in a compute resource efficient performance product distribution system.

FIG. 10 depicts a flowchart of an example of a method for managing compute resource efficient performance product distribution.

### DETAILED DESCRIPTION

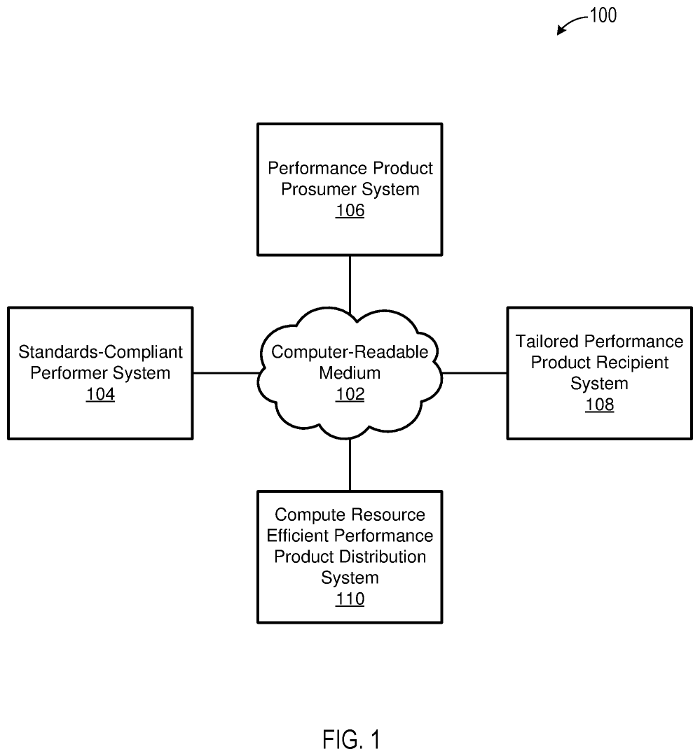

FIG. 1 depicts a diagram 100 of an example of a parameterized compute resource efficient, tailored-and-standards-compliant performance product marketplace. The diagram 100 includes a computer-readable medium 102, a standards-compliant performer system 104 coupled to the computer-readable medium 102, a performance product prosumer system 106 coupled to the computer-readable medium 102, a tailored performance product recipient system 108 coupled to the computer-readable medium 102, and a compute resource efficient performance product distribution system 110 coupled to the computer-readable medium 102.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 and other systems and devices described in this paper can, if applicable, be implemented as a computer system, a plurality of computer systems, or parts of a computer system or a plurality of computer systems. In general, a computer system will include a processor, memory, non-volatile storage, and an interface and the examples described in this paper assume a stored program architecture, though that is not an explicit requirement of the machine. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. A typical CPU includes a control unit, arithmetic logic unit (ALU), and memory (generally including a special group of memory cells called registers).

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

In stored program architectures, software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes one or more hardware processors or a portion thereof. A portion of one or more processors can include some portion of hardware less than all of the hardware comprising any given one or more processors, such as a subset of registers, the portion of a processor dedicated to one or more threads of a multi-threaded processor, a time slice during which a processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality distributed. With the understanding an engine, as used in this paper, includes one or more hardware processors or a portion thereof (hereinafter, referred to as the “processor”), an engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The standards-compliant performer system 104 is intended to represent one or more devices used by a performer to manage a performer account and to create and make available at least standards-compliant performance content for inclusion in a tailored performance product. Depending upon implementation-specific or other considerations, the standards-compliant performer system 104 can include or be coupled to a display for displaying graphical user interface (GUI) including text, images, and/or video according to received data to present performer account creation prompts, components of a performance product request, or the like. Depending upon implementation-specific or other considerations, the standards-compliant performer system 104 can include either or both a wired or wireless interface, which may include a microphone, camera, or other input devices, for generating text, video, or other appropriate responses to performer account creation prompts, performance product requests, or the like. For example, the standards-compliant performer system 104 can include or be coupled to an electromechanical device capable of recording still and video images and/or recoding sound and generate electric image signal and/or audio signal based on the record to generate a portion of a performance product. Depending upon implementation-specific or other considerations, the standards-compliant performer system 104 can include either or both a wired or wireless interface, which may include a radio, Ethernet port, or other I/O devices, for transmitting account creation responses, performance product components, or the like through a wired or wireless connection. The standards-compliant performer system 104 can include a thin client device or an ultra-thin client device, and can comprise more than one device. Depending upon implementation-specific or other considerations, the standards-compliant performer system 104 can include a mobile computing device, such as a smartphone, a tablet, a laptop, a smart watch, a digital video camera, and so on.

In a specific implementation, performers include notable people, such as artists, actors, sports professionals, politicians, business leaders, models, game designers, and so on. Notable people need not necessarily be famous, and could include otherwise unknown heroes, like firefighters, relatively unknown specialists, like lawyers or architects, or some other notable category. A performer need not be singular; a performer may include multiple individuals (e.g., sports team, band members). A performer may be an actor pretending to be a not-necessarily-human entity, such as an iconic character (e.g., Santa Claus), an animated character (brought to life by an artist and voice actor), a fictional character, an impersonator of a famous person, and so on, and may entail the use of a costume. A performer must meet certain requirements to be considered a standards-compliant performer. A performance must meet certain requirements to be considered a standards-compliant performance. Details regarding the data structures used to encapsulate a standards-compliant performer and a standards-compliant performance product, the latter of which can also be referred to as a “performance product that includes a standards-compliant performance,” are provided later.

The performance product prosumer system 106 intended to represent one or more devices used by a performance product requester to manage a performance product requester account and to tailor performance product. A prosumer is intended to mean a person or agent thereof who tailors and purchases a performance product. In an alternative, the parties responsible for requesting and tailoring a performance product are not the same (or agents of the same) party, in which case the prosumer could be referred to as a “multi-party prosumer” as distinguishable from a “single party prosumer.” Tailoring a performance product can include creating text or other content in an effort to provide instructions for tailoring a performance for inclusion in a tailored performance product, previewing a prior performance product or a proposed performance product; providing delivery details (e.g., a performance product recipient email address or physical address); and/or taking other actions in association with a performance product request (or preparation thereof). A tailored performance product request includes parameterized instructions (e.g., a language preference, pronunciation assistance, age-appropriateness guidelines, choreography requests, or the like) regarding words to be spoken by the performer and/or actions to be performed by the performer. A tailored performance product request can include a purpose for the performance, information about a tailored performance product requester, information about a performance product recipient, a relationship between the tailored performance product requester and the performance product recipient. Details regarding the data structures used to encapsulate a tailored performance product request are provided later.

In a specific implementation, the performance product prosumer system 106 includes or is coupled to a display for displaying graphical user interface (GUI) including text, images, and/or video to present performance product requester account creation prompts, components of a performance product request, or the like. Depending upon implementation-specific or other considerations, the performance product prosumer system 106 can include either or both a wired or wireless interface, which may include a microphone, camera, or other input devices, for generating text, video, or other appropriate responses to performance product requester account creation prompts, tailored performance product request instructions, or the like. For example, the performance product prosumer system 106 can include or be coupled to an electromechanical device capable of recording still and video images and/or recoding sound and generate electric image signal and/or audio signal based on the record to generate tailored performance product request instructions. Depending upon implementation-specific or other considerations, the performance product prosumer system 106 can include either or both a wired or wireless interface, which may include a radio, Ethernet port, or other I/O devices, for transmitting account creation responses, tailored performance product request instructions, or the like through a wired or wireless connection. The performance product prosumer system 106 can include a thin client device or an ultra-thin client device, and can comprise more than one device. Depending upon implementation-specific or other considerations, the performance product prosumer system 106 can include a mobile computing device, such as a smartphone, a tablet, a laptop, a smart watch, a digital video camera, and so on.

The tailored performance product recipient system 108 intended to represent one or more devices capable of, at least for a portion of a performance product that can be received, receiving a performance product and, for at least a portion of a performance product that can be played on a playback device, playing the performance product. In general, the tailored performance product recipient system 108 can include hardware similar to (though often not the same as) that described in association with the tailored performance product prosumer system 106. A performance product recipient will generally need to be able to receive receivable content, play playable content, and, if applicable, provide feedback. For a performance product that includes tangible items, such as a signed picture of the performer, a physical address may be considered part of the tailored performance product recipient system 108, and for intangibles, such as a right to attend a performance, the recipient may need to travel to a destination, such as a concert put on by the relevant performer, so the tailored performance product recipient system 108 can be considered to include some form of transportation device, if applicable.

In a specific implementation, a performance product includes a video (or audio clip) of a performer uttering a message, such as a birthday message, a celebration message, an encouraging message, a greeting message, a gift message, and so on. The video can be augmented with CGI or other post-production augmentations. Some portion of the performance product can also be live, such as a live stream. A performance product may or may not include tangible items, such as a gift card, a gift, a product associated with a performer (e.g., product of a performer's brand), a signed picture of a performer. A performance product may or may not include non-tangible privileges, such as a pass to an event associated with a performer, an invitation to meet a performer, an early access to an event associated with a performer, non-public information about a performer (e.g., clothes the performer is going to wear at an upcoming event). Details regarding the data structures used to encapsulate a performance product are provided later.

The compute resource efficient performance product distribution system 110 is intended to represent hardware configured to establish a platform from which parameterized performance products can be offered.

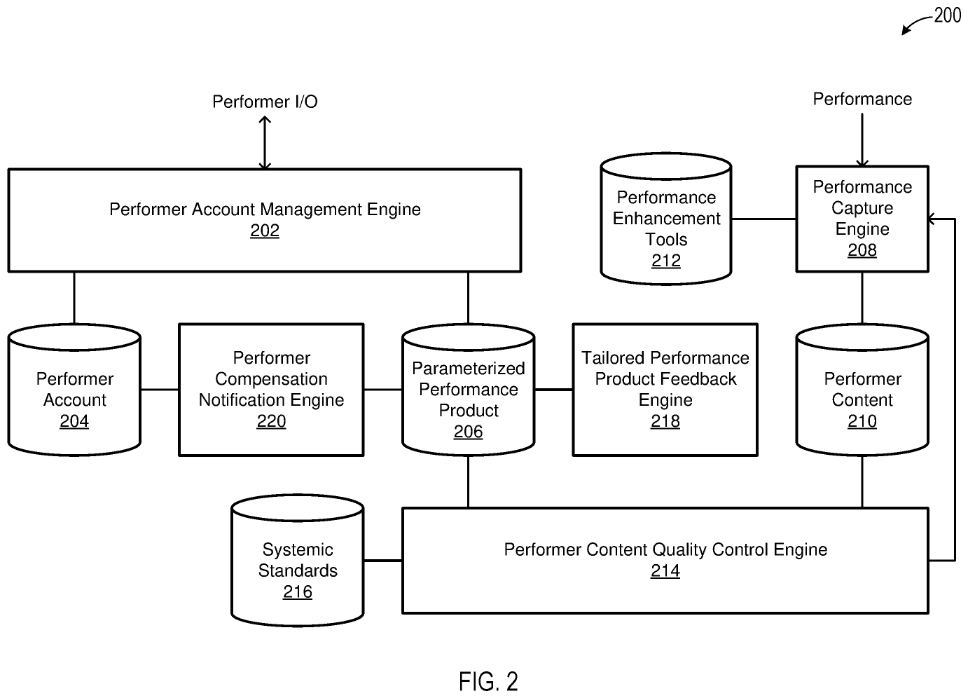

FIG. 2 depicts a diagram 200 of an example of a standards-compliant performer system for interacting with a performer in association with the generation of a parameterized performance product. The diagram 200 is intended to represent hardware configured to receive and display data in association with performer account creation and management, to capture standards-compliant performer content for inclusion in parameterized performance products, to improve quality through content quality control, and to provide notifications regarding performance product feedback and performer compensation. The diagram 200 includes a performer account management engine 202, a performer account datastore 204 coupled to the performer account management engine 202, a parameterized performance product datastore 206 coupled to the performer account management engine 202, a performance capture engine 208, a performer content datastore 210 coupled to the performance capture engine 208, a performance enhancement tools datastore 212 coupled to the performance capture engine 208, a performer content quality control engine 214 coupled to the parameterized performance product datastore 206 and the performer content datastore 210, a systemic standards datastore 216 coupled to the performer content quality control engine 214, a tailored performance product feedback engine 218 coupled to the parameterized performance product datastore 206, and a performer compensation notification engine 220 coupled to the performer account datastore 204 and the parameterized performance product datastore 206.

The performer account management engine 202 is intended to represent hardware configured to manage a performer account in a parameterized compute resource efficient, tailored-and-standards-compliant performance product marketplace. In a specific implementation, the performer account management engine 202 generates a performer registration request for creation of a performer account. In generating a performer registration request, the performer account management engine 202 prompts a performer, or a human or artificial agent thereof, for data about the performer. Depending upon implementation- and/or configuration-specific factors, data about the performer can include name, date of birth, contact information, financial information (e.g., bank account information, credit card information, or tax ID), performance product enhancement field values (e.g., gender, nationality, language proficiency, claim-to-fame, to name several), a price range or a per-product price for performing, or a limitation on duration or number of performances (in total or over a given time). Performance product enhancement field values are stored as parameters that match performer qualifications for a parameterized performance product. Performance product enhancement field values can be used to search for or filter performers by matching the performance product enhancement field values to search criteria. Depending upon implementation- and/or configuration-specific factors, performance product enhancement field values may or may not be used for automated price and/or compensation calculations. When input is expected from a human performer or agent, a GUI can be used to prompt the human for input and to display information to the human.

The performer account datastore 204 includes performer data, which may be stored locally relative to the performer account management engine 202 (in whole or in part), remotely at a third party location (e.g., in the cloud), or locally relative to a parameterized performance product distribution system (in whole or in part). Performer data may be referred to as performer records, but it should be understood “records” is not intended to necessitate a particular database format, but rather represents the applicable format of data. A performer account can include performer records managed by the performer or an agent thereof, which may or may not have create, read, update, and delete (CRUD) restrictions with respect to the performer, other performers, performance product requesters, performance product recipients, or other parties associated with a performance product marketplace and, in a specific implementation, performer records managed by a party other than the performer.

In a specific implementation, performer records includes a biometric record (e.g., voice, video image of a face and/or the entire body, or a fingerprint image) as part of a standards-compliant performer data structure, which can be used for verification of a performer. Where the biometric record includes a video, it may be desirable to include instructions to a performer to ensure only the performer could be the one creating the biometric video. For example, a performer could be told to say a passphrase at the start of a video to ensure someone else didn't just create a clip of the performer unbeknownst to the performer. If only verification is required to be compliant with performer standards, when a performer is verified, the performer can be referred to as a standards-compliant performer. Other standards may also be required, such as background data matching a performance persona. For example, a performer who claims to have a major league baseball player performance persona needs to provide data sufficient to prove the performer was a major league baseball player. Standards compliance may also mandate a background check to ensure a performer is not a sexual predator, is not a felon, etc. The combination of the various systemic requirements into the biometric record can be referred to as a standards-compliant biometric record.

Instead or in addition, standards may vary depending upon a performance product requester's specifications. Thus, a standards-compliant performer will need to meet both performance product marketplace system standards and requester-specific standards. The biometric record may or may not be used for the requester-specific standards. For example, a performance product requester could request a Brazilian athlete and the performer record may include a demographics record sufficient to show a performer is both Brazilian and an athlete, without recourse to a biometric record.

The parameterized performance product datastore 206 includes parameterized performance product records. A “parameterized” performance product is intended to mean a performance product that has parameters that can be matched to appropriate performers (and other tangible or intangible product or service providers, if applicable). The performer account management engine 202 can update prospective performance product records with a minimally tailored performance, performer preferences (including requirements), performance prices, and the like. A minimally tailored performance is intended to include pre-recorded performances that address a specific recipient. For example, a minimally tailored performance could include a birthday performance for a 49-year-old woman named Shannon, potentially including a splice of a birthday performance for a 49-year-old and a birthday performance for a woman named Shannon. A performance that is prepared upon request can be referred to as a custom performance, but tailored is intended to include both custom and minimally tailored performance products unless otherwise indicated explicitly or by context in this paper.

In a specific implementation, a performance product distribution system uses prospective performance product records to determine what performance products can be offered. The performer account datastore 204 and the parameterized performance product datastore 206 can be physically or logically overlapping in the sense a performer can indicate in advance of a tailored performance product request performance parameters, which could be characterized, at least conceptually, as being part of the performer account datastore 204 (e.g., as performer preferences) or as being part of the parameterized performance product datastore 206 (e.g., as performance product parameters). For illustrative purposes, hereinafter in this paper, any performer preferences are treated as a filter for parameterized performance products such that a performer is only identified as a possible performer for a prospective parameterized performance product if the performer preferences match performance product request parameters.

Instead or in addition, the parameterized performance product datastore 206 can include requested performance product records. A tailored performance product request can trigger the creation of a new performance product record. After the performance product record has been created, the performance product record can be matched to a relevant performer.

The performance capture engine 208 is intended to represent hardware configured to record a performance by a performer in a parameterized compute resource efficient, tailored-and-standards-compliant performance product marketplace. Depending upon implementation-specific or other considerations, the performance capture engine 208 can use a GUI to prompt a performer. In a specific implementation, advance of a performance (or contemporaneously therewith) the performer account management engine 202 can provide relevant data from the parameterized performance product datastore 206 to a performer to assist in the performance. For example, the performer can be told the presentation should include “Happy 11^{th} Birthday, Yuki!” as part of the presentation, which the performer can then take into account when performing. More generally, information useful to a performer can include a purpose of a performance, information of a performance requester (potentially with some redact for personal information), information of a performance receiver (potentially with some redact for personal information), requests to use (or not use) specific words, phrases, or sentences, pronunciation guidelines, language-specifications, context, deadlines, requests to make (or not make) specific gestures, poses, or actions, and pricing, to name several.

The performer content datastore 210 includes content captured by the performance capture engine 208. The performer content datastore 210 is intended to represent performances, or portions thereof, that are controlled by the performer. Therefore, performances in the performer content datastore 210 need not comply with systemic or other standards.

The performance enhancement tools datastore 212 includes tools that assist in the enhancement of a performance. Enhancements can include video editing tools, a library of still or video images (which may or may not be done by the performer), or the like. In a specific implementation, a performance enhancement tool can be used to insert a visual effect (e.g., animation, frame, caption etc.), a sound effect, a background scene, or a background music; to crop, trim, or edit an image; or to adjust framerate, splice, or otherwise reorganize a performance. CRUD rights to certain tools may or may not be restricted depending upon the performer. For example, some performers might be “subscribing” performers who pay a subscription to use the performance product marketplace, while other performers might be “opportunistic” performers who do not pay for a subscription and perform on request. In an implementation in which at least some of the tools are paid-for, the performance capture engine 208 processes payment, or acts as an interface to a payment processing engine, for use of a performance production tool, when use of a performance production tool is chargeable to the performer. Some tools might include performer content, and the performer has CRUD rights, while other tools might be shared, so the performer has only read rights.

The performer content quality control engine 214 is intended to represent an engine that compares performer content with systemic standards (e.g., you are who you say you are) or request-specific (e.g., performance is in a requested language, includes certain words, or includes certain actions) for compliance in a parameterized compute resource efficient, tailored-and-standards-compliant performance product marketplace. A human or artificial quality control engineer can observe, test, or otherwise check content to ensure compliance. The arrow from the performer content quality control engine 214 back to the performance capture engine 208 is intended to represent detection of non-compliant performer content, followed by a redo by the performer. For illustrative purposes, it is assumed the performer content eventually is made standards-compliant and the performer content quality control engine 214 updates the parameterized performance product datastore 206 to include the standards-compliant performer content.

The standards can require the use of a library (not shown) to convert a file format of a performance to a requested format or a standardized format or, more generally, to make performer content standards-compliant when it is possible to do so through a mechanism that does not involve the performer redoing a performance. Although the performer content has been made standards-compliant, that does not necessarily mean all values of the performance product parameters are standards compliant because there may or may not be some additional parameters that have associated standards-compliance checks; a performance product would not be characterized as “standards-compliant” until it is completed as requested. (Note: an off-the-shelf performance product can be standards-compliant prior to a request being made, such as with minimally tailored birthday wishes for a 11-year-old girl named Yuki.) When the parameterized performance product has all relevant performer content, the parameterized performance product can be characterized as a “tailored” performance product.

The systemic standards datastore 216 includes standards with which all performances must comply. There can be standards which must be met by all performers for authenticity, copyright, production quality, and rating (e.g., Rated G, PG, PG-13, R, NC-17, or some other categorization), to name several. It is assumed for illustrative purposes the performer content quality control engine 214 can find request-specific parameters in the parameterized performance product datastore 206. A parameterized performance product can be offered in a performance product marketplace with access to the parameterized performance product datastore 206, the contents thereof, or a portion thereof, and a tailored, standards-compliant performance product can be provided to a performance product recipient.

The tailored performance product feedback engine 218 is intended to represent hardware configured to provide a performer feedback regarding a parameterized performance product during or after a request is made by a requester who provides feedback; after a tailored, standards-compliant performance product has been received by a performance product recipient who provides feedback; or by a performance product distribution system agent that provides feedback about an aspect of performance, marketing, or the like (potentially with suggestions about how to improve sales) in a parameterized compute resource efficient, tailored-and-standards-compliant performance product marketplace. It is not a requirement that a performer necessarily receive feedback regarding all aspects of a performance product; the feedback could be limited to the performance portion of the performance product. It is not a requirement that a performer necessarily receive a push notification of feedback; the feedback could be in the form of an updated parameterized performance product datastore 206 such that the performer can access the feedback if the performer accesses the relevant parameterized performance product datastore 206. In a specific implementation, the tailored performance product feedback engine 218 sends a notification to a performer via email, messaging, or other channel when a feedback field of a performance product record in the parameterized performance product datastore 206 is updated. Alternatively, a feedback field of a performance product record in the parameterized performance product datastore 206 could be updated without sending a notification, and a performer could access the feedback through the performer account management engine 202 by checking the performance product record explicitly, checking updates, checking a summary of performance products, or the like.

The performer compensation notification engine 220 is intended to represent hardware configured to provide a performer notification of compensation for at least a performance portion of a performance product in a parameterized compute resource efficient, tailored-and-standards-compliant performance product marketplace. In a specific implementation, the parameterized performance product datastore 206 is updated with compensation information (e.g., by a parameterized performance product marketplace agent) and the performer compensation notification engine 220 detects the update and notifies the performer regarding the compensation. Although payment processing for purchasing a performance product could be carried out at or through a performer system, the example of FIG. 1 assumes payment processing is carried out by or through a performance product marketplace payment processing engine, a third party payment processing engine, or some other payment processing engine remote relative to the performer system. In a specific implementation, compensation can be made via deposit to a financial account (e.g., bank account, bitcoin account, credits in the content-analyzed performance marketplace, etc.) associated with the performer and may or may not include an identification of the specific performance product for which compensation is being received. A bank statement, deposit summary, or other financial statement can be considered, for illustrative purposes, to be part of the performer account datastore 204 (and a browser used to interface with a bank can be considered part of the performer account management engine 202). When conceptualizing in this manner, “account” is essentially an overloaded term that refers to either a performer account in a performance product distribution system or, e.g., a bank account of the performer in a finance management system.

In an example of operation of the example system shown in FIG. 2, the performer account management engine 202 generates a performer registration request on behalf of a performer, which is sent to a performance product distribution system. The performance product distribution system registers the performer and creates, allows creation of, or does not prohibit creation of a performer account. Performer account state is maintained in the performer account datastore 204. The performer account datastore 204 may include data available to both the performer and the performance product marketplace, such as a user identification (uid), and to both the performer and some other system, such as a banking system. After a performance account is created, the performer account management engine 202 can include performer preferences in the parameterized performance product datastore 206, which can be treated as parameterized performance products with parameters that do not have final values. The parameterized performance product datastore 206 can be modified to include requests for performance products and, if the performer matches parameters of the requested performance product, the performer can be prompted to perform pursuant to the request. The performance capture engine 208 captures the performance of the performer and stores it in the performer content datastore 210. The performer can create content in advance of a request and reuse content created for a first requested performance product in a second requested performance product. The performance capture engine 208 has access to editing tools in the performance enhancement tools datastore 212, which can be used to modify media, including the performer content, in any applicable manner. The performer content quality control engine 214 ensures performer content that is to be included in a parameterized performance product meets quality control requirements, which are stored in the systemic standards datastore 216, and addresses instructions in a performance product request, which are stored in the parameterized performance product datastore 206 in association with the relevant performance product(s). The performer content quality control engine 214 hands off to the performance capture engine 208 as long as the relevant performer content is not standards-compliant and, once the performer content is standards compliant, stores the performer content in association with the relevant performance product(s) in the parameterized performance product datastore 206. The tailored performance product feedback engine 218 provides feedback that is stored in the parameterized performance product datastore 206 in association with the relevant performance product(s). The performer compensation notification engine 220 informs a performer, or an agent thereof, when compensation is made for performance product(s) associated with the performer and/or when compensation is detected at a financial institution, such as a deposit into a checking account.

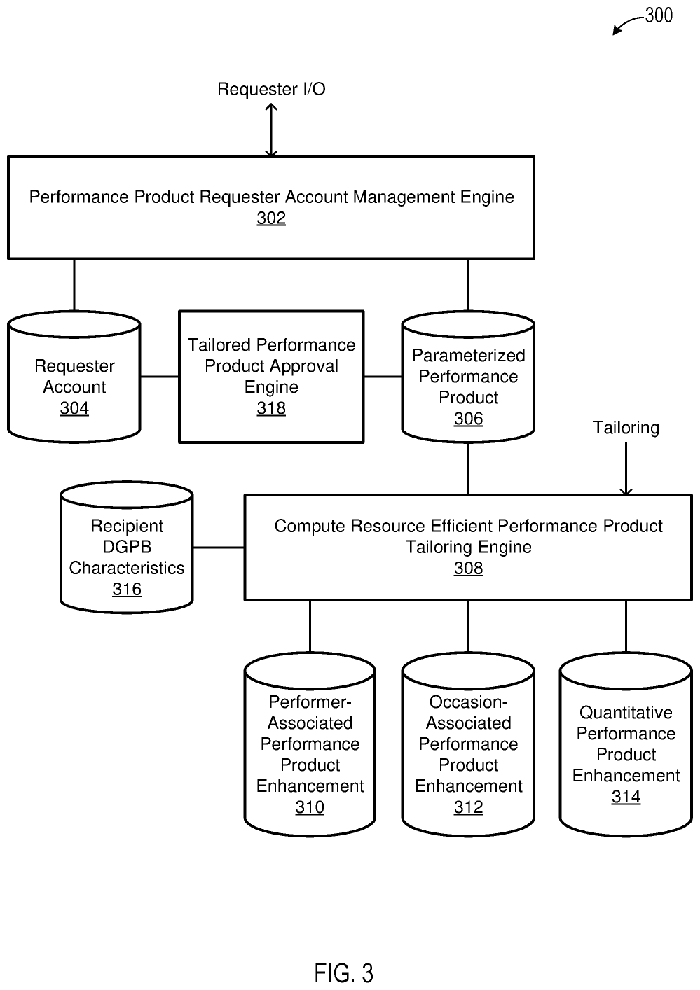

FIG. 3 depicts a diagram 300 of an example of a performance product prosumer system for tailoring and requesting a tailored performance product. The diagram 300 includes a performance product requester account management engine 302, a requester account datastore 304 coupled to the performance product requester account management engine 302, a parameterized performance product datastore 306 coupled to the performance product requester account management engine 302, a compute resource efficient performance product tailoring engine 308 coupled to the parameterized performance product datastore 306, a performer-associated performance product enhancement datastore 310 coupled to the compute resource efficient performance product tailoring engine 308, an occasion-associated performance product enhancement datastore 312 coupled to the compute resource efficient performance product tailoring engine 308, a quantitative performance product enhancement datastore 314 coupled to the compute resource efficient performance product tailoring engine 308, a recipient demographic, geographic, psychographic, and/or behavioristic (DGPB) characteristics datastore 316 coupled to the compute resource efficient performance product tailoring engine 308, and a tailored performance product approval engine 318 coupled to the requester account datastore 304 and the parameterized performance product datastore 306.

The performance product requester account management engine 302 is intended to represent hardware configured to manage a performance product requester account in a parameterized compute resource efficient, tailored-and-standards-compliant performance product marketplace. In a specific implementation, the performance product requester account management engine 302 generates a performance product requester registration request for creation of a performance product requester account. In generating a performance product requester registration request, the performance product requester account management engine 302 prompts a potential requester, or a human or artificial agent thereof, for data about the request. Depending upon implementation- and/or configuration-specific factors, data about the request can include name, date of birth, contact information, and financial information. When input is expected from a human performance product requester or agent, a GUI can be used to prompt the human for input and to display information to the human.

The requester account datastore 304 is intended to represent hardware configured to maintain state associated with a requester account. State can include non-volatile storage state as well as real-time state. In a specific implementation, a performance product requester need not have a performance product requester account until after participating up to some point in a performance product search, tailoring, or request. For example, a potential performance product requester could visit a parameterized compute resource efficient, tailored-and-standards-compliant performance product marketplace webpage using a browser. The potential performance product requester could use filters to find a performer whose performance they would like to include in a performance product, browse a catalog of potential enhancements to the performance product, and indicate the occasion for which the performance product is being requested, with or without entry of required parameter information (for who, from who, relationship, one or two additional parameter information that varies with occasion, and at least one specification). Typically, though not necessarily, the performance product requester account would be created before a first request for a tailored performance product is finalized, before a performer is asked to provide performance content, and/or when payment is due.

The parameterized performance product datastore 306 is intended to maintain state associated with multiple parameterized performance products or portions thereof. For illustrative convenience, the parameterized performance product datastore 306 is treated as including performance products at any point in their lifecycle, from a parameterized compute resource efficient performance product template to a parameterized compute resource efficient, tailored-and-standards-compliant performance product deliverable (and a historical record thereof). For illustrative convenience, the parameterized performance product datastore 306 is treated as if it includes all relevant data associated with a performance product, including gender preferences and pricing. However, as is discussed later in more detail, a compute resource efficient performance product data structure will include a relatively small subset of the available data. For example, a parameterized performance product can include a “for whom” parameter, a “from whom” parameter, a “relationship” parameter, and performer instructions to include a specific word, phrase, or action; a pronunciation guide; a language preference; a context; a deadline; or prohibited words, phrases, or actions.

A performance product request state need not be associated with a requester account. For example, state can include behavioristic data associated with a potential performance product requester, such as a visitor to a performance product marketplace website, who has no requester account. On the other hand, a performance product request state can be associated with a requester account, if the requester account exists and can be tied to a current performance product request state.

The compute resource efficient performance product tailoring engine 308 is intended to represent hardware configured to provide performance product enhancement tools to a human or artificial party suitable for use in tailoring a performance product with a data structure suitable for improving compute resources at stages of performance product development from parameterized performance product template storage, to parameterization processing, to bandwidth resource reduction during transmission, to parameter requirement fulfilment, and to performance product deliverable storage. In a specific implementation, the compute resource efficient performance product tailoring engine 308 provides a GUI to a human to receive tailoring instructions and provide performance product enhancement status, such as performer search and selection results. The performance product data structure, including advantages associated therewith, is discussed in more detail below.

The performer-associated performance product enhancement datastore 310 is intended to represent searchable and selectable performance product enhancement field values associated with potential performers. Performer-associated performance product enhancement fields can include gender, nationality, language proficiency, claim-to-fame (e.g., occupation), or the like, that are descriptive of the performer (or at least descriptive of a role played by the performer). Performance product enhancement fields can be considered part of a performer account that can be shared (either by making the value of the field visible when viewing a performer profile or by making the field matchable without making the data viewable), though the data may be in a different physical or logical datastore than that of the performer account. The compute resource efficient performance product tailoring engine 308 finds or assists in finding a match for parameters of a performance product as the performance product is tailored. However, only those fields that are necessary for a performer to know are included in the performance product. For example, a performance product prosumer may want a performer of a particular gender, but the performance product does not need a gender parameter because the performer will be whatever gender the performer is. Similarly, a price for a performance should be searchable because a prosumer will want to know what they have to pay for a performance product and/or what performance products are available within a given price range, but need not be conveyed back to a performer.

The performer-associated performance product enhancement datastore 310 can also include entries associated with tangible or intangible goods or services associated with a performer. For example, a major league baseball player could offer a signed baseball, mitt, baseball card, or the like as a tangible that can be selected to enhance a performance product, or the performer could provide an invitation to meet at a baseball game. Tangible or intangible goods or services associated with a performer will typically increase a tailored performance product price by an amount that is determined by performer preferences (including requirements), market value, mark-ups, or the like. In a specific implementation, the performer-associated performance product enhancement datastore 310 includes sales pitches, sample performances, or other content from performers or agents thereof provided for the purpose of encouraging the use of performance product enhancements.

The occasion-associated performance product enhancement datastore 312 is intended to represent searchable and selectable entries associated with tangible or intangible goods or services associated with a chosen occasion. For example, if, in tailoring a performance product, an occasion is indicated to be a birthday, the occasion-associated performance product enhancement datastore 312 can be filtered for birthday-related items, like birthday cakes, birthday party locations, or the like. Depending upon implementation- and/or configuration-specific factors, the goods and services identifiable in the occasion-associated performance product enhancement datastore 312 could be associated with a performer via a royalty or mark-up that is attributable to the performer, or by a relationship with performer's occupation (e.g., a baseball-themed cake in a performance product that includes performance content from a former major league baseball player). For illustrative purposes, the occasion-associated performance product enhancement datastore 312 is assumed to include occasion-associated goods and services, even if they are also associated with a performer.

The quantitative performance product enhancement datastore 314 is intended to represent searchable and selectable entries associated with tangible or intangible goods or services that are agnostic with respect to a performer or occasion. For example, a gift card could be selectable from the quantitative performance product enhancement datastore 314 that is related to neither the performer nor the occasion, but is added to enhance the size of the performance product and provide the different parts of the performance product as a conceptually unitary gift.

The recipient DGPB characteristics datastore 316 is intended to represent data about an intended recipient of a tailored performance product that can be used to choose a performer with which the recipient has an identifiable affinity. For example, a toddler demographic might appreciate happy birthday wishes from the person who voices Curious George (perhaps even in partial or full animated form if copyright issues can be accounted for); a child who lives in Manchester, UK might appreciate happy birthday wishes from George Best, Cristiano Ronaldo, or Bobby Charlton of Manchester United; a person who can be categorized in accordance with a personality trait scale (e.g., O.C.E.A.N. or Myers-Briggs) can be associated with performers who suit their personalities (perhaps along with some music); and a person who purchased Star Wars on Amazon might appreciate happy birthday wishes from Mark Hamill or George Lucas. (High net worth individuals might perform for the benefit of their favorite charities, while performers of lesser means might actually need the income.) The data can be spread across many platforms, but at some point at least a subset of the data will be represented relatively locally (e.g., in a buffer for display in a browser).

Although not shown in the example of FIG. 3, a tailored request quality control engine can carry out contextual analysis and/or compliance analysis of a performance product request. In a specific implementation, the tailored request quality control is limited to contextual analysis that requires limited processing resources (e.g., power, time), but is sufficient to reduce the likelihood of performers receiving offensive or abusive requests. Quality control can be based upon systemic standards and/or performer preferences. Depending upon implementation- and/or configuration-specific factors, a non-compliant request can result in notification to a prosumer that the performance product request requires modification (and the prosumer may or may not be informed the request violates system or performer-specific requirements), a prosumer's account could be suspended or canceled, and/or a performer could be warned that the request is non-compliant and give the performer the option to view (and perhaps even respond to) a non-compliant performance product request.

In a specific implementation, the compute resource efficient performance product tailoring engine sets a tailoring complete flag in the parameterized performance product datastore 306 that indicates a tailored performance product has been fashioned by a prosumer. (The flag can be implemented in an applicable manner.) The tailoring complete flag triggers the performance product requester account management engine 302 to prompt a requester for payment. When the payment obligations are fulfilled, the performance product requester account management engine 302 sets a request complete flag in the parameterized performance product datastore 306 that indicates various parties can fulfil open parameter requirements.

In the specific implementation described in the preceding paragraph, when a request complete flag is set, a tailored performance product, or relevant portions thereof, are made available to a standards-compliant performer system capable of fulfilling the requirements of an open parameter, such as by providing a standards-compliant tailored video of the performer. A compute resource efficient performance product distribution system may also gain access at this time, or the system may have access the entire time, depending upon implementation- and/or configuration-specific factors. The compute resource efficient performance product distribution system may be responsible for fulfilling requirements of other open parameters, such as providing standards-compliant tailored performance product deliverables to a performance product recipient system. Other requirements may or may not include activities associated with delivering (and perhaps obtaining) tangible or intangible goods or services. Third party services may or may not also be employed to fulfil open parameter requirements, such as a gift purchased through Amazon.com, either by the requester or an agent associated therewith or through the compute resource efficient performance product distribution system, which could include an engine that, for example, places an order on behalf of a prosumer.

When a performance product parameter requirement is fulfilled, such as when a performer provides a performance portion of a performance product, a requester can review the performance product in its current state through the tailored performance product approval engine 318. At any time in the performance product lifecycle, subject to implementation- and/or configuration-specific factors, a requester can have access to the performance product. In a specific implementation, the tailored performance product approval engine 318 sets the approved flag in the parameterized performance product datastore 306 (presumably) when the requester or other party acting on behalf of the requester approves the performance product for delivery. When the approved flag is set, or any time up to that time, the performance product requester account management engine 302 prompts a requester or agent thereof to fulfill payment obligations. For example, the performance product requester account management engine 302 can use financial data in the requester account datastore 304 to transfer cash from the control of the requester to the control of the performer or some other party associated with the tailored performance product.

In a specific implementation, the tailored performance product approval engine 318 carries out a mediation process in the event a requester refuses to approve a tailored performance product. The mediation process may result in changing from a first performer to a second performer, modifying tangible or intangible goods or services associated with other performance product parameters, a discount, or a refund.

When approved and all open parameters are fulfilled, a performance product deliverable flag is set in the parameterized performance product datastore 306, which is visible via the performance product requester account management engine 302. In a specific implementation, the tailored performance product approval engine 318 facilitates the provisioning of feedback from the requester or a party acting on behalf of the requester.

In an example of operation of the example system shown in FIG. 3, the performance product requester account management engine 302 creates an account on behalf of a requester, the compute resource efficient performance product tailoring engine 308 enhances a performance product template in accordance with tailoring specifications, and the tailored performance product approval engine 318 indicates a tailored performance product has been approved for delivery. It may be noted that when the requester (consumer) and the party providing tailoring instructions are the same party, the requester can be referred to as a prosumer. Other performance product marketplace participants, such as a standards-compliant performer system and a compute resource efficient performance product distribution system, fulfil tailored performance product parameter requirements (probably) prior to the tailored performance product is approved. In the example of operation of the example system shown in FIG. 3, the performance product requester account management engine 302 facilitates payment by the requester for the tailored performance product.

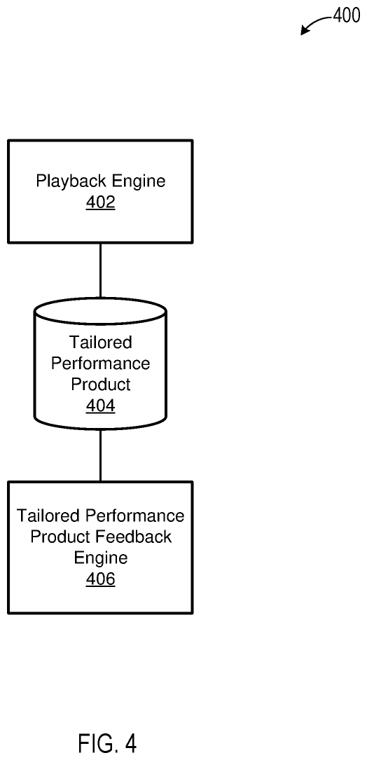

FIG. 4 depicts a diagram 400 of an example of a tailored performance product playback system for playback of a multimedia portion of the tailored performance product. The diagram 400 includes a playback engine 402, a tailored performance product datastore 404 coupled to the playback engine 402, and a tailored performance product feedback engine 406 coupled to the tailored performance product datastore 404.

The playback engine 402 is intended to represent hardware configured to enable playback of an electronic portion of a tailored performance product deliverable stored in the tailored performance product datastore 404. In a specific implementation, the playback engine 402 is local relative to the tailored performance product datastore 404, which includes the entirety of an electronic portion of a tailored performance product. The electronic performance of the tailored performance product can be received via a network interface in the form of a file download from a relatively remote location, in the form of a file upload from a physical storage device, such as a DVD or flash memory drive, or in some other applicable manner.

In an alternative, the playback engine 402 is local relative to the tailored performance product datastore 404, but the tailored performance product datastore 404 does not contemporaneously store the entirety of an electronic portion of a tailored performance product. For example, the playback engine 402 could play streaming media that includes the electronic portion of the tailored performance product, the entirety of which is stored at a relatively remote location (e.g., in the cloud), and only a subportion of which is contemporaneously local relative to the playback engine 402. As such, the tailored performance product datastore 404 could be characterized as a buffer.

The tailored performance product feedback engine 406 is intended to represent hardware configured to enable provisioning of feedback from a recipient of the tailored performance product, or an agent thereof. In a specific implementation, the playback engine 402 and the tailored performance product feedback engine 406 are implemented on the same device (e.g., a smartphone). The tailored performance product feedback engine 406 stores feedback in the tailored performance product datastore 404. In a specific implementation, the feedback is entered into a browser or an app and transmitted over the Internet to a parameterized performance product datastore accessible by a performer and/or some other performance product marketplace participant. Alternatively, the feedback can be more free-form, such as an email with feedback recorded therein.

It should be understood, the tailored performance product playback system illustrated by way of example in FIG. 4 can include a network interface for receipt of electronic goods, a physical mailbox for receipt of tangible goods, and/or a transportation device for moving the recipient to a relevant venue for goods or services that are not delivered to a recipient, such as an invitation to meet a performer in person.

In an example of operation of the example system shown in FIG. 4, the playback engine 402 plays back at least a performance portion of a tailored performance product in the tailored performance product datastore 404. Other portions of the tailored performance product in the tailored performance product datastore 404 may be represented as messages pertaining to tangible or intangible items, such as a note that says “you will be receiving a book from Amazon!” or a link to a location from which tickets to a concert can be printed and a code that can be entered to get the tickets for free. The tailored performance product feedback engine 406 can provide feedback entered into the tailored performance product datastore 404 on the tailored performance product and/or a portion of the performance product.

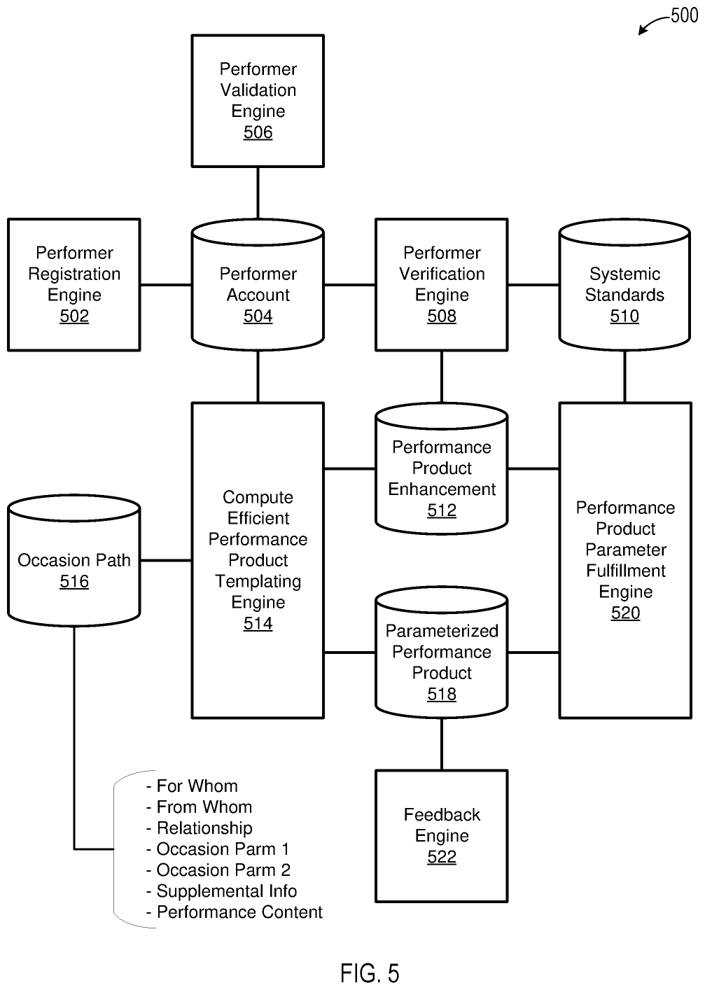

FIG. 5 depicts a diagram 500 of an example of a compute resource efficient performance product distribution system. The diagram 500 is intended to represent a system in which a prosumer can tailor a parameterized performance product, have all of the parameter requirements of the parameterized performance product fulfilled, and have the tailored performance product provided to a tailored performance product recipient. The diagram 500 includes a performer registration engine 502, a performer account datastore 504 coupled to the performer registration engine 502, a performer validation engine 506 coupled to the performer account datastore 504, a performer verification engine 508 coupled to the performer account datastore 504, a systemic standards datastore 510 coupled to the performer verification engine 508, a performance product enhancement datastore 512 coupled to the performer verification engine 508, a compute efficient performance product templating engine 514 coupled to the performance product enhancement datastore 512, an occasion path datastore 516 coupled to the compute efficient performance product templating engine 514, a parameterized performance product datastore 518 coupled to the compute efficient performance product templating engine 514, a performance product parameter fulfillment engine 520 coupled to the systemic standards datastore 510, the performance product enhancement datastore 512, and the parameterized performance product datastore 518, and the performance product feedback engine 522 coupled to the parameterized performance product datastore 518.

The performer registration engine 502 is intended to represent hardware configured to process a performer registration request. In processing a performer registration request, the performer registration engine 502 considers performer information from a performer or a human or artificial agent acting on behalf of the performer and potentially from other sources, as well.

The performer account datastore 504 is intended to represent a repository of performer information entered by a performer or a human or artificial agent acting on behalf of the performer via a standards-compliant performer system and from other sources, such as from a background check, talent agency, data mining of social or news media, or the like. Some or all of the performer account datastore 504 may be accessible to the relevant performer, likely with at least some security measures implemented, such as uid and password. To the extent the performer account datastore 504 has data that is shared across multiple disparate systems, such as a standards-compliant performer system and a compute resource efficient performance product distribution system, the performer account datastore 504 can be implemented as a shared datastore, a distributed datastore, a copied datastore, or distinct datastores that are updated using messages, such as a performer account registration request from a standards-compliant performer system to a compute resource efficient performance product distribution system that informs a second datastore of at least some of the information in a first datastore. The information can include demographic, geographic, psychographic, behavioristic, and unique data, such as name, date of birth, gender, nationality, language proficiency, resume, financial information, biometric data (e.g., voice, video image of a face and/or the entire body, etc.), as well as performer preferences, such performance pricing (e.g., a fixed $10 for a performance, a range of $10-$30 for a performance, or pricing that depends upon type, such as video, song, dance, or the like, occasion, such as birthday, sympathy, wedding, or the like, length, resolution, bitrate, etc.) and performance availability. The performer account datastore 504 can be augmented over time from the same or different sources, including, for example, a performance product prosumer system or a tailored performance product recipient system. In a specific implementation, the performer registration engine 502 enables access to the performer account datastore 504 (or to a separate datastore that is more localized relative to the performer system) while a new account is being created, but with limited (or no) access to other distribution system services until the performer has been validated and/or verified.

The performer validation engine 506 is intended to represent hardware configured to determine whether a performer persona that has been represented to a distribution system has been presented by the performer or human or artificial agents acting on the performer's behalf, which can be referred to as validating a performer. The performer validation engine 506 uses the performer account datastore 504 to validate a performer. In a specific implementation, the performer validation engine 506 uses biometric information from the performer account datastore 504 to ensure the performer or an agent therefor is creating an account. For example, the performer could be asked to say a passphrase on video. In a specific implementation, the performer validation engine 506 has verification sensitivity levels that depend on how famous, controversial, litigious, or in some other way more prone to be imitated, a performer is. For example, the performer validation engine 506 uses a higher validity threshold for pattern matching as the risk of imitation of a performer increases. In another example, the performer validation engine 506 employs more variety of verification methods as the publicity and/or popularity of a performer increases. A risk of imitation algorithm can weight quantitative (e.g., how many hits do you get when searching for the performer, how many SNS followers does the performer have, etc.) and qualitative (e.g., how much do people actually like to imitate the performer, Wikipedia entries, etc.) factors to set the validity threshold for a performer.

In a specific implementation in which the performer validation engine 506 uses pattern matching, the performer validation engine 506 may employ a specific pattern matching algorithm to determine a matching degree, and determine a matching status when a specific criteria is satisfied. The specific criteria may include one or more of a condition that a matching degree exceeds a predetermined threshold, a condition that a sum of a plurality of matching degrees exceeds a predetermined threshold, and a condition that a number of a plurality of matching degrees that exceed a predetermined threshold exceeds a predetermined number. As another example, the performer validation engine 506 performs pattern matching of visual information (e.g., face image) of a performer received from a performer with visual information (e.g., face image) of the performer received from public sources (e.g., social networking sites (SNS), video streaming sites such as YouTube, Netflix, and Hulu, etc.). As another example, the performer validation engine 506 uses pattern matching of official information (e.g., image of driver license) of a performer with visual information (e.g., live video image) of the performer. As another example, the performer validation engine 506 performs pattern matching of vocal information (e.g., utterance of specific word(s)) of a performer received from the performer with vocal information (e.g., utterance of specific word(s)) of the performer received from public sources (e.g., SNS, video streaming sites, etc.). As another example, the performer validation engine 506 performs pattern matching of both visual and vocal information. As another example, the performer validation engine 506 uses computer-based graphoanalysis of handwritings written by a performer.

In a specific implementation, the performer validation engine 506 sets a validity flag to “valid” for a performer account in the performer account datastore 504 associated with the performer, which can give a performer or a person acting on the performer's behalf to access data associated with performance products or performance product enhancement (without actually authorizing the performer to fulfill parameter requirements for tailored performance products or to be made available to prosumers to include in tailored performance products, assuming there is a subsequent performer verification process).

The performer verification engine 508 is intended to represent hardware that verifies self-reported credentials of a validated performer, categorizes the performer if no adequately self-categorized, and verifies systemically required standards are met by the validated performer. The performer verification engine 508 uses the performer account datastore 504 to verify a performer's resume, to categorize the performer, and/or to ensure the performer meets systemic requirements to participate in a performance product distribution system. In an implementation in which resumes of performers are checked by the performer verification engine 508, the performer verification engine 508 can employ human or artificial agents to confirm aspects of the resume, such as using background checks, talent agency inquiries, contacting references, Wikipedia, or the like.

In an implementation in which performers are categorized by the performer verification engine 508 (e.g., performers do not have absolute freedom to self-categorize), the performer verification engine 508 categorizes a performer into searchable fields to enable a prosumer to more easily tailor a performance product with a performer of a desired category. The performer verification engine 508 can use predetermined categories, learn additional categories from performer input (e.g., self-categorization) or prosumer input (e.g., attempts to search for types of performers that are not yet categorized), and/or identify categories from other sources, such as talent agencies, news feeds, and social networks. Performer categories can be stored in the performer account datastore 504 and a performer account in the performer account datastore 504 can be designated as having one or more of the particular categories, as appropriate for the performer associated with the performer account. Examples of performer categories include artist, actor, athlete, politician, business leader, model, game designer, lawyer, architect, fireman, teacher, to name several. In a specific implementation, the performer verification engine 508 allows self-categorization by a performer to the extent the self-categorization cannot be disproved (e.g., a major league baseball player self-categorization can be removed if the performer verification engine 508 is unable to find a performer who is self-categorized as such in a reasonably comprehensive source of major league baseball players) or to the extent the system does not yet have a formal categorization. Similarly, performers may be allowed to self-categorized, but only those who are verified can have a symbol or text next to the categorization that indicates the performer is “verified.” As such, an actor could self-categorize as a number of different occupations, but only be a verified actor (or perhaps not even be verified as an actor). Category verification may or may not require evidence of a paid position in the indicated category (e.g., a major league baseball player) or evidence of competition as the indicated category (e.g., an amateur wrestler), and categories can include codified ranks within the category, such as minor league or major league (for a baseball player) or All-American for a wrestler. In a specific implementation, the performer verification engine 508 collects search key inputs stats, counts category terms (e.g., baseball player) input together with a specific name of a performer, and determines a category of the performer based on the counts. Depending upon implementation-specific or other considerations, the performer verification engine may associate a performer with a plurality of categories, such as actor and model, or ex-professional golfer and politician.

In an implementation in which the performer verification engine 508 reduces the risk performers deviate from systemic requirements for performers used to create performance products, the performer verification engine 508 can employ human or artificial agents to perform background checks, including many sources by which a resume might be verified, but also more likely including checking sexual predator databases, public bankruptcy information, and the like.

In a specific implementation, the performer verification engine 508 sets a verification flag to “verified” for a performer account in the performer account datastore 504 associated with the performer, which can give a performer or a person acting on the performer's behalf to access data associated with performance products or performance product enhancement, the ability to fulfill parameter requirements for tailored performance products, and the advantage to be made available to prosumers to include in tailored performance products, assuming there is no subsequent activation step (following, e.g., entry of financial information). Alternatively or in addition, the verification flag can be made applicable to a set of distinct performer criteria. For example, a performer can be verified as a major league baseball player, but perhaps not verified as a native speaker of Spanish, even if self-identified as such.

The systemic standards datastore 510 includes the standards performers must meet to be verified performers in a specific implementation of a performance product distribution system. The systemic standards datastore 510 may or may not also include information that is utilized to confirm performance product requests are standards-compliant at a performance product prosumer system. The systemic standards datastore 510 may or may not also include information that is utilized to confirm performance content to be included in performance products are standards-compliant at a standards compliant performer system.

The performance product enhancement datastore 512 includes tools and content, or links thereto, that can be used to enhance performance products. The performance product enhancement datastore 512 may or may not include tools or content that is utilized by prosumers to specify components of a tailored performance product and/or by performers to enhance performances. Components of the performance product enhancement datastore 512 may be behind a paywall or otherwise reserved for specific prosumers or performers based upon characteristics of a prosumer, a performer, and/or a performance product. The performer verification engine 508 can mark entries of the performance product enhancement datastore 512 as usable by performers who have the prerequisites (e.g., those who have adequate experience, those who have gotten behind a paywall, those who meet performance category requirements, or the like).

The compute efficient performance product templating engine 514 is intended to represent hardware configured to generate parameterized performance products that are compute efficient and suitable for tailoring. In a specific implementation, the compute efficient performance product templating engine 514 uses the performer account datastore 504 to make performers matchable to a parameterized performance product. Performers may be matchable to parameterized performance product if the performer matches a price associated with the performance product, a performer category, or is capable of utilizing performance product enhancement tools that are associated with the performance product, to name a few. When tailoring the parameterized performance product, a prosumer can search for an appropriate performer, the performer can be prompted to provide a performance, and the performance content can be used to fulfill the requirements of the tailored performance product by slotting performance content into a parameter of the originally templated parameterized performance product data structure. Other parameters of the parameterized performance product enable compute efficient communication of performance parameter requirements for the performer when appropriate values, such as a “for whom” parameter so the performer knows to whom to address a message and other parameters mentioned at various places in this paper, are provided to the parameters.

In a specific implementation, the compute efficient performance product templating engine 514 uses the performance product enhancement datastore 512 to associate certain performance product enhancement tools with a performance product. Pricing can be automated in accordance with various factors, which may or may not impact performance product enhancement options. For example, the performance product templating engine 514 can take prices or price ranges in the performer account datastore 504 and apply a formula to obtain a new price or price range for a parameterized performance product. In a specific implementation, formula parameters weight performer preferences, performer category, performer credentials, performer popularity (e.g., number of followers), and performance product sales (e.g., with more recent sales weighted more heavily than less recent sales) differently.

The occasion path datastore 516 includes data structures used by the compute efficient performance product templating engine 514 to generate compute efficient data structures. By providing occasion paths, the compute efficient performance product templating engine 514 can create performance products that are more readily streamlined, are more efficiently stored, and can be provided to performers in a more efficient (in terms of bandwidth and dwell time) manner. In the example of FIG. 5, a bracket of parameters is depicted for the purpose of illustrating occasion path parameters. In the diagram 500, three parameters are occasion-agnostic, “for whom,” “from whom,” and “relationship,” two parameters are occasion-specific, “occasion parm 1” and “occasion parm 2,” and one parameter is a catch-all that is intended to be made as small as possible to improve efficient use of compute resources, without loss of data that is necessary to meet parameterized requirements for a performance product.

In a specific implementation, there are five types of occasions, which will have varying effects on occasion parm 1 and occasion parm 2. For a first three types of occasions, occasion parm 1 includes a date. Occasion type 1 is an “static milestone” occasion. Static milestones include coming of age ceremonial occasions (e.g., Baha'i, Bar Mitzvah, Bat Mitzvah, Bhrataman, Civil Confirmation, Communion, Confirmation, Debut, Guan Li, Ji Li, Quinceanera, Ritushuddhi, Shinbyu, Sweet 16, Upanayana, or the like), union (marriage) ceremonial occasions, and recurring events that are not typically tallied (e.g., New Year, Epiphany, Martin Luther King Jr.'s Birthday, Groundhog Day, Lincoln's Birthday, Valentine's Day, Presidents' Day, Washington's Birthday, Ash Wednesday, Purim, St. Patrick's Day, St. Joseph's Day, April Fools' Day, Palm Sunday, Passover, Good Friday, Tax Day, Easter, Earth Day, Administrative Professionals Day, National Day of Prayer, Cinco de Mayo, National Nurses Day, Mother's Day, Armed Forces Day, Vernal Equinox, Ramadan, Memorial Day, Flag Day, Father's Day, Summer Solstice, Eid al-Fitr, Independence Day, Friendship Day, Sisters' Day, Labor Day, Grandparents Day, National Day of Service and Remembrance, Citizenship Day, Rosh Hashanah, Autumnal Equinox, Yom Kippur, Clergy Appreciation Day, Columbus Day, National Boss Day, Diwali, Sweetest Day, United Nations Day, Halloween, All Saints' Day, Election Day, Veterans Day, Thanksgiving, Hanukkah, Winter Solstice, Christmas, Kwanzaa). Recurring events can vary depending upon culture (e.g., Sweet 16), nation (e.g., Independence Day), or geographic location (e.g., Winter Solstice). The static milestone occasion subtype (e.g., Baha′i) is indicated in occasion parm 2.

Occasion type 2 is an “incremental milestone” occasion. Incremental milestones include anniversaries and birthdays. The date of an incremental milestone is indicated in occasion parm 1 and the current milestone of an incremental milestone is indicated in occasion parm 2. For example, if the birthday is a 7^{th} birthday, the occasion parm 2 will include the value “7^{th} birthday.” It may be noted that when a performance product is being tailored, a prosumer need not know what occasion type is being indicated. For example, if a 16^{th} birthday is indicated for a “for whom” with a relationship “daughter,” the prosumer can be prompted whether to refer to the birthday as a “sweet 16” birthday and the performance product can be for a static milestone occasion, even though the prosumer entered “birthday” as the occasion.

Occasion type 3 is a “message-related institution” occasion. Message-related institutions include graduation and retirement (including discharge from the military). The date of a message-related institution is indicated in occasion parm 1 and the message-related institution is indicated in occasion parm 2. The message-related institution is the school (for graduation) and a company or branch of service (for retirement). In a specific implementation, the value of occasion parm 2 is “Graduated (Name_of_School)” or “Retired (Name_of_Company or Branch_of_Service).” In an alternative, occasion parm 1 includes a date range, which represents a start date (first day of school, enlistment date, first day at company, etc.) and an end date (graduation, discharge, or retirement). Alternatively or in addition, a welcome back message could be included, if it is deemed to be worth the additional complexity, and the occasion parm 2 could include “Welcome Back (From_Where)” as another possible value. Welcome back could be for a person who was overseas, a person who was wrongly convicted and released from prison, or the like. Alternatively or in addition, a request message could be included, and occasion parm 2 would include “Request (What)” as another possible value, but occasion parm 1 would include the future date. For example, for a request to go to prom, occasion parm 1 could include the date of the prom and occasion parm 2 could include “Request (go to prom).”

Occasion type 4 is a “message-related entity” occasion. Message-related entities include babies (births), children (baptisms or the like), and the deceased (sympathy). An aspect of message-related entities is that the performance product is for someone other than the subject of the occasion, such as a parent or loved one. The name of the message-related entity is indicated in occasion parm 1 and the occasion subtype is indicated in occasion parm 2 (e.g., birth, baptism, death). In an alternative, message-related institution and message-related entity occasion types are combined into a single occasion type. Specifically, occasion parm 1 can include a NULL date, a date, or a date range that is indicative of don't care, the date of the event, or the lifespan (for sympathy) or years of service (for retirement or discharge from the military), and occasion parm 2 can include the message-related entity (in this alternative, the term “entity” is intended to include both humans, institutions, and legal entities). In this alternative, occasion parm 2 could include “Graduated (Name_of_School),” “Retired (Name_of_Company or Branch_of_Service),” Birth (Name_of_Baby),” “Baptism (Name_of_Child),” or Sympathy (Name_of_Deceased).” Also, “Baptism” can be replaced with any applicable ceremony or event that would prompt a prosumer to send a performance product to a loved one, rather than the message-related entity, such as adoption.

Occasion type 5 is an undated occasion. Undated occasions include congratulations, encouragement, get well, just because, love, proposal, request, thank you, or the like. A request can include asking someone out on a date. A proposal can include a marriage proposal. The “why” is included in occasion parm 1 and the occasion subtype is included in occasion parm 2.

Each occasion type can include supplemental information, which is intended to represent any data that could not be parameterized into the five basic parameters. Supplemental information may or may not be necessary; it could be provided redundantly to ensure a performer knows how to pronounce names, can double-check the automated parameterization, or the like, or non-redundantly, providing information that was not parameterized in the five basic parameters. A performance content parameter is a parameter that is templated to contain performance content or a link to performance content provided by a performer or agent thereof; the initial template may or may not include a stock or sample performance, but the performance content parameter is associated with parameter fulfillment requirements, some of which can be added, modified, or removed during tailoring.

The parameterized performance product datastore 518 includes the “blank” parameterized performance product templates generated by the compute efficient performance product templating engine 514. In time, the performance product parameter fulfillment engine 520 can create instances of the parameterized performance product templates and see to the provisioning of values for the various parameters that do not deviate from systemic and prosumer-indicated parameter requirements.

In a specific implementation, the performance product parameter fulfillment engine 520 is intended to represent hardware that detects when a parameterized performance product template has been tailored by a prosumer, the tailoring of which results in the creation of an instance of the parameterized performance product template, and when all parameter requirements for an instance have been fulfilled. The instantiation can be detected when a performance product request is received over a network interface from a performance product prosumer system, an access is made to the parameterized performance product datastore 518 from a performance product prosumer system, or the like. The performance product parameter fulfillment engine 520 can be implemented as a web server that facilitates the tailoring of a parameterized performance product by a client at a performance product prosumer system using a browser, as an app server that allows a client at a performance product prosumer system to download the tools necessary to tailor a parameterized performance product, or as a message server that receives tailored performance product requests generated entirely outside of the control of the performance product parameter fulfillment engine 520 and prompts parties, including a performer, to fulfill parameter requirements, to name a few options. In any case, whether the performance product parameter fulfillment engine 520 makes changes to the parameterized performance product datastore 518 in accordance with prosumer instructions provided in real time, receives a complete performance product request from a performance product prosumer system and updates the parameterized performance product datastore 518 accordingly, or detects changes to the parameterized performance product datastore 518, the performance product parameter fulfillment engine 520 eventually prompts a performer to fulfill a performance content parameter of the tailored performance product.

In a specific implementation, the performance product parameter fulfillment engine 520 is configured to generate a formatted performance request based on processing of a performance product request including at least one of linguistic analysis, context analysis, and compliance analysis to identify detailed contents of the performance request. In a specific implementation that includes contextual analysis, the performance product parameter fulfillment engine 520 uses contextual analysis techniques to identify a context of a performance product request. For example, through the contextual analysis, the performance product parameter fulfillment engine 520 can determine an occasion for which a performance is being requested, characteristics of a performance product requester, characteristics of a performance product recipient, a relationship between the performance product requester and the performance product recipient. Alternatively or in addition, contextual analysis can reveal timing for completing a performance, providing a performance product to a performance product recipient, or the like. For example, the performance product parameter fulfillment engine 520 can use contextual analysis to determine a performance is for a birthday that is on a specific date, enabling a conclusion that the performance product should be received on the specific date. In another example, the performance product parameter fulfillment engine 520 determines a specific characteristic (e.g., a geographical location of the performance receiver system) that can be used to modify performance product characteristics, such as by adjusting delivery date depending upon the time zone of the performance product recipient. In a specific implementation, to carry out contextual analysis, the performance product parameter fulfillment engine 520 employs a natural language processing (NLP) algorithm and determines “from whom,” “to whom,” “by whom,” “when,” “where,” “why,” and “how” a performance product is created and provided based on the specific NLP algorithm, a subset of which may be included in the formatted performance product request. The specific NLP algorithm may further involve a specific statistical natural language processing (SNLP) to obtain more reliable conclusions from the context.

In a specific implementation, the performance product parameter fulfillment engine 520 carries out contextual and/or linguistic analysis of a performance product request to identify parameterizable contents of the performance request, which are stored in the relevant parameter field. For example, a performance product request that includes an audio file with the contents, “Please wish my daughter, Yuki, a happy birthday; she is going to be 11 in two days” could be parsed to obtain for whom (Yuki), from whom (requester), relationship (daughter), date (timestamp+2 days), milestone (11), and occasion (birthday). Because linguistic analysis can be imperfect, it may be desirable to keep the audio recording in some instances, but the tailored performance product is fully parameterized and it is a more efficient use of compute, storage, and bandwidth resources to record only the parameterized portions. Depending upon implementation- and/or configuration-specific factors, the tailored performance product may also include an audio file that simply includes the word “Yuki,” and that acts as a pronunciation guide. Contextual analysis can enable parameterization of imprecise performance product requests. In the example provided above, the requester's name can be read from a requester account (assuming the name has been provided) and the date of the occasion can be derived as two days, which is explicit in the request, from the date of the request, which was not explicit in the request, but which can be derived from a timestamp. Superior contextual analysis can enable identification of performance types, occasions, relationships, etc. without having the parameterizable data explicitly stated using public or private data. For example, a geographical location of a prosumer and a tailored performance product recipient can provide useful context regarding performer cues or more applicable performance product enhancements that might not be available from linguistic analysis alone.

Contextual and linguistic analysis can also be used to determine whether a performance product request is standards-compliant. In a specific implementation, the performance product parameter fulfillment engine 520 uses the systemic standards datastore 510 to compare a performance request to standards. Alternatively or in addition, the performance product parameter fulfillment engine 520 uses the performer account datastore 504 to compare a performance request to performer preferences (including requirements). Standards can include prohibited language (e.g., abusive, discriminatory, provocative, or other undesirable language). Standards may also prohibit requesting certain actions in violation of standards or the law, such as a request to make an improper gesture, do something illegal, violate copyrights, etc. A performance product request that meets the standards can be referred to as a standards-compliant request.

In carrying out the compliance analysis, in a specific implementation, the performance product parameter fulfillment engine 520 compares words requested in a performance product request with restricted words in the systemic standards datastore 510 (or performer account datastore 504 if the performer has restrictions on performance requests) to detect improper word use. In carrying out the compliance analysis, in a specific implementation, the performance product parameter fulfillment engine 520 compares a context (e.g., purpose, action to be performed, etc.) determined through the context analysis with restricted purposes and/or restricted actions to detect improper context and/or actions. In a specific implementation, the performance product parameter fulfillment engine 520 searches a performance request for restricted words to be pronounced, searches the performance request for restricted actions to be performed (and context), and determines that the performance request is a standards-compliant performance request when no restricted words and no restricted actions (and context) are found in the performance request.

In a specific implementation, a formatted performance product request includes an instruction for proper pronunciation of a word, which is useful, for example, for a performer or agent thereof to pronounce the word and/or when performing linguistic analysis of performance content. In a specific implementation, through the linguistic analysis, the performance product parameter fulfillment engine 520 determines a specific pronunciation of a word (e.g., name of a performance recipient) to be pronounced by a performer and generates a pronunciation instruction (e.g., sample audio data, phonetic symbols, etc.). For example, the performance product parameter fulfillment engine 520 can compare a plurality of samples of utterance data of a same or similar word that are obtained from previous performance product requests or other sources to predict a proper pronunciation of a word in a performance product request. The performance product parameter fulfillment engine 520 may or may not put different weights on different samples of utterance data depending on matching and non-matching of language designated by a performance requester and languages set for the different samples. For example, the performance product parameter fulfillment engine 520 may put more weight on samples in the same language as the language designated by a performance requester and put less weight on samples in different languages from the language designated by the performance requester.

Instead or in addition, a formatted performance product request includes instructions about a performance feature, such as a sound effect, a background scene, a background music, or the like, and a requester may or may not have the option of providing enhancement tools (potentially behind a paywall) to a performer or to be made available to a performer, for example, through a performance product distribution system. Instead or in addition, the formatted performance product request can include a prohibition against words or actions. In a specific implementation, a formatted performance product request has a performance due date indicative of when all performance product parameters have been fulfilled or one or more due dates for individual performance product parameters.

The performance product parameter fulfillment engine 520 is intended to represent hardware configured to provide a performance production suite, or a portion thereof, a performer can use to provide a performance content portion of a performance product. In a specific implementation, the performance production suite includes a performance product request, or relevant portion thereof, a sample performance (e.g., a real, animated, or pictographic representation of a performance; a summary, flowchart, or detailed description of a performance; etc.), a video and/or audio of a performance product prosumer, video and/or audio editing tools, raw video and/or audio contents that can be incorporated into a performance product, etc. In a specific implementation, the performance production suite includes a tool to insert a visual effect (e.g., animation, frame, caption, etc.), a sound effect, a background scene, a background music, and a tool to trim and/or reorganize a performance record. In a specific implementation, use of a performance production suite, or portions thereof, costs a fee, and the fee may be charged to a performance requester and/or a performer depending on specifics of a performer account, requester account, or performance product. For example, when a performance product prosumer requests use of a specific performance production tool or specific effect, the fee may be charged to a requester account. In another example, when a performance product prosumer does not request use of a performance production tool or specific effect, but a performer wishes to use the tool or effect, the fee may be charged to a performer account. Some performance product tools or special effects may be provided to some performers and not to others, depending upon contractual agreements, performance, or other factors. The production tools and special effects available for various performers may or may not be displayed when a prosumer is searching for a performer to use in a performance product. In charging a fee for a performance production suite, or portion thereof, the performance product parameter fulfillment engine 520 requests a performer system and/or a performer requester system to input payment information, if applicable.

In a specific implementation, performance product standards include systemic and request-abiding standards corresponding to contents of a performance request. For example, when a performance product request requests singing a specific song and/or specific lyrics, the request-abiding standard is met when a performance product includes specific song and/or specific lyrics. In another example, when a system standard prohibits addition of advertisement by a performer, the systemic standard is met when a performance product includes no advertisement by the performer. In a specific implementation, a standard includes one or more of prohibited words or actions, enforced using an honor system (self-regulation), contextual and/or linguistic analysis, periodic compliance checks, or the like.

When a performer fails to provide a standards-compliant performance, depending upon implementation- and/or configuration-specific factors, the performer may be requested to redo the performance or a portion thereof, the requester may be requested to modify the performance request (due to, e.g., an after-the-fact requirement from the performer, such as “I do not feel comfortable fulfilling this request”), or compliance may be enforced without additional input from the prosumer or performer (e.g., converting from a performance content file format, such as AVI, to a system-standard or prosumer-requested format, such as 3GPP).

In a specific implementation, the performance product parameter fulfillment engine 520 allows a prosumer to approve a performance, once it is made available by a performer system. Depending upon implementation- and/or configuration-specific factors, when a performance product is denied by a performance requester, the performance product parameter fulfillment engine 520 prompts a prosumer for additional information if the denial did not include adequate reasons for the disapproval; prompts a performer for a secondary performance in accordance with after-the-fact requirements, standards compliance (if standards-compliance procedures failed to detect compliance prior to the prosumer indicating disapproval), or customer service policy (of the performer or system); addresses the disapproval without prompting the performer (though a notification may still be provided to the performer) if the performer properly fulfilled the performance product parameter requirements; or takes other applicable action. In sending a secondary performance request, the performance product parameter fulfillment engine 520 may or may not charge a requester account, depending on reasons for disapproval of a performance product. When approved, the performance product parameter fulfillment engine 520 sets a prosumer-approved flag in the parameterized performance product datastore 518. The prosumer-approved flag may or may not be indicative of a standards-compliant tailored performance product deliverable depending upon whether all other performance parameter requirements have been fulfilled. Once fulfilled, the tailored performance product deliverable can be made available to a tailored performance product recipient system.

The performance product feedback engine 522 is intended to represent hardware configured to facilitate feedback regarding a parameterized performance product from relevant systems, such as a standards-compliant performer system, a tailored performance product prosumer system, a tailored performance product recipient system, and/or a compute resource efficient standards-compliant tailored performance product distribution system, and make the feedback available to relevant systems, such as a standards-compliant performer system, a tailored performance product prosumer system, and/or a compute resource efficient standards-compliant tailored performance product distribution system. The performance product feedback engine 522 stores feedback in the parameterized performance product datastore 518, which is made available to parties with read access to the datastore. In a specific implementation, feedback includes ratings and/or comments about parameters of performance product, combinations of parameters of performance product, or a performance product as a whole. Depending upon implementation-specific or other considerations, feedback can impact performer accounts (e.g., ratings associated with a performer, compensation, etc.), requester accounts (e.g., coupon-availability, superuser rankings, etc.), and a relevant parameterized performance product (e.g., popularity, modifications by a templating engine in response to feedback, etc.). Depending upon implementation-specific or other considerations, the performance product feedback engine 522 may or may not generate a report about aggregated performance products created by a specific performer based on feedback, aggregated performance products tailored by a prosumer, aggregated performance products that used specific enhancement tools, or the like.

In an example of operation of the example system shown in FIG. 5, the performer registration engine 502 updates the performer account datastore 504 with a new performer account, which the performer validation engine 506 validates to prove the performer account is for the performer alleged, and which the performer verification engine 508 uses the systemic standards datastore 510 and other sources to confirm the performer's credentials are as represented, are standards-compliant, and are updated to conform to reliable data found about the performer (including re-categorizing the performer relative to self-reported categorization, if appropriate). The performer verification engine 508 also controls rights to entries in the performance product enhancement datastore 512 and in association with the performer account datastore 504, if applicable. The compute efficient performance product templating engine 514 creates “blank” performance product entries using the performer account datastore 504 to associate matchable performers with a template, the performance product enhancement datastore 512 to associate performance product enhancement tools and content with the template, and the occasion path datastore 516 for compute efficiency depending upon occasion type (and subtype, if applicable) for storage in the parameterized performance product datastore 518. The performance product parameter fulfillment engine 520 obtains from a performance product prosumer system a standards-compliant tailored performance product request using the systemic standards datastore 510 to ensure standards-compliant requests (and optionally the performer account datastore 504 to ensure performer-requirements-compliant requests) and the performance product enhancement datastore 512 to enable the selection of applicable enhancement options for an instance of a parameterized performance in the parameterized performance product datastore 518. The performance product parameter fulfillment engine 520 obtains a performance portion of the requested tailored performance product request from a standards-compliant performer system, along with other parameter fulfillments from other parties, if applicable. In a typically final act for the engine (though not necessarily for the performance product lifecycle), the performance product parameter fulfillment engine 520 fulfils the requirement that the tailored performance product in the parameterized performance product datastore 518 be made available to a recipient of the intended recipient (identifiable at least from a “for whom” parameter of the performance product). The feedback engine 522 stores feedback in the parameterized performance product datastore 518 in association with the tailored performance product and the party providing the feedback, whether that party is the performer, the prosumer, the recipient, or some other party.

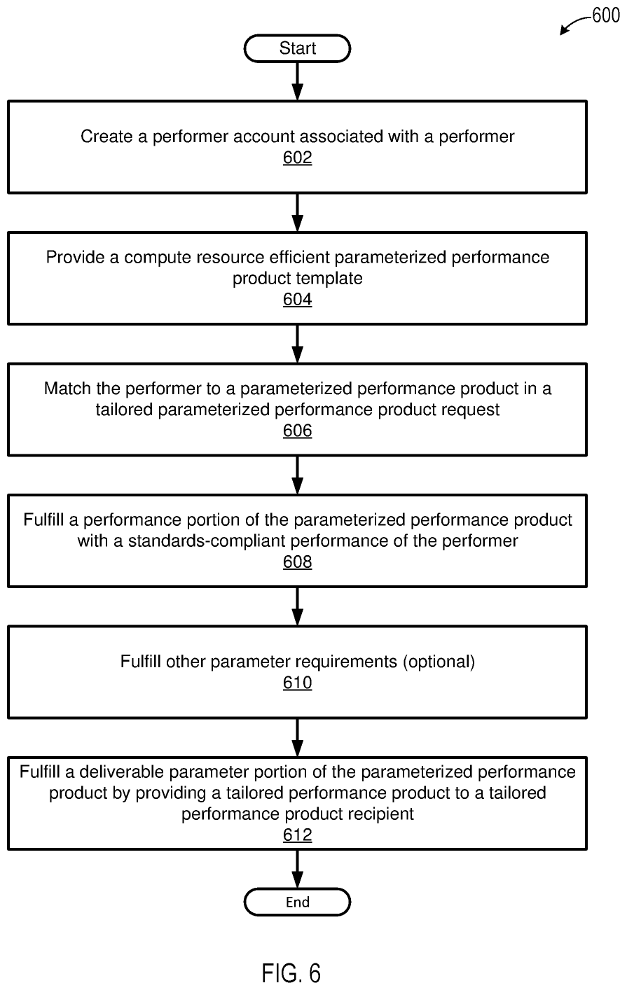

FIG. 6 depicts a flowchart 600 of an example of a method for distributing a parameterized compute resource efficient, tailored-and-standards-compliant performance product. This flowchart and the other flowcharts described in this paper illustrate modules (and potentially decision points) organized in a fashion that is conducive to understanding. It should be recognized, however, that the modules can be reorganized for parallel execution, reordered, modified (changed, removed, or augmented), where circumstances permit. The flowchart 600 begins at module 602 with creating a performer account associated with a performer. In this context, “associated with” means a performer can be uniquely identified from the performer account with which the performer is associated. Creating a performer account may involve registration, validation, and verification of the performer at a standards-compliant performance product distribution system. A performer account can include performer preferences (including requirements) related to pricing for performances, tailored performance product requests, self-reported performer characteristics, discovered (i.e., not self-reported) performer characteristics, and financial information that can be used, for example, to accept payment from the performer for performer marketing and/or advertising, performance product leads, performance enhancement tools, or the like and that can be used, for example, to make payment to the performer for performances and advertising revenue attributable to the performer.

The flowchart 600 continues to module 604 with providing a compute resource efficient parameterized performance product template. A template can be created for each of a plurality of occasion paths, each of a plurality of performer categories or performance types, each of a plurality of performance product enhancement options, and/or permutations thereof. Parameterization improves compute efficiency by reducing bandwidth requirements for transmitting performance products, reducing storage requirements, and reducing dwell time for a performer. Parameterization also allows relevant parties to fulfill parameter requirements efficiently and in parallel (with some obvious exceptions, such as a deliverable parameter requirement cannot be met until at least some of the relevant performance product parameters related to the deliverable have been fulfilled, the failure of which would mean there is nothing to deliver).

The flowchart 600 continues to module 606 with matching the performer to a parameterized performance product in a tailored parameterized performance product request. A prosumer can be broken into multiple parts, all of which can be done by a single entity or shared across multiple entities that comprise the prosumer. A first part is requesting, which is intended to mean setting up an account responsible for paying for a performance product. A second part is tailoring, which is intended to mean providing parameter requirements suitable to tailor a performance product for a specific recipient. It is the tailoring part that is typically responsible for matching one or more performers to the parameterized performance product. A third part is approving, which is intended to mean checking one or more performance product parameters to see that they met the performance product parameter requirements. (Not all distribution systems necessarily will allow approval of every parameter or even any parameters, in some cases.) A fourth part is feedback, which is intended to mean providing free-form or parameterized (i.e., per-parameter) feedback regarding aspects of the performance product distribution (e.g., feedback about the performer, the distribution system, the performance enhancements, or the like).

The flowchart 600 continues to module 608 with fulfilling a performance portion of the parameterized performance product with a standards-compliant performance of the performer. The performer responsible for fulfilling the performance portion can use performance enhancement tools, if applicable, to provide a typically multimedia performance for inclusion in the performance product. The performance is checked for compliance with standards and/or performance parameter requirements from the tailored performance product request.

The flowchart 600 continues to module 610 with fulfilling other parameter requirements. Module 610 is optional because it is possible to have only two parties responsible for fulfilling parameter requirements, the performer (module 608) and the delivery system (module 612). However, if there are additional parameters that need be fulfilled, such as tangible or intangible gifts that need be obtained for inclusion in the tailored performance product, such additional parameters are fulfilled.

The flowchart 600 continues to module 612 with fulfilling a deliverable parameter portion of the parameterized performance product by providing a tailored performance product to a tailored performance product recipient. Fulfilling the deliverable parameter portion may or may not entail sending the performance product, in whole or in part, to the tailored performance product recipient from a single location. For example, the deliverable parameter portion can be fulfilled by orchestrating delivery of portions of the tailored performance product from multiple different locations, or otherwise making one or more portions of the tailored performance product available to the tailored performance product recipient.

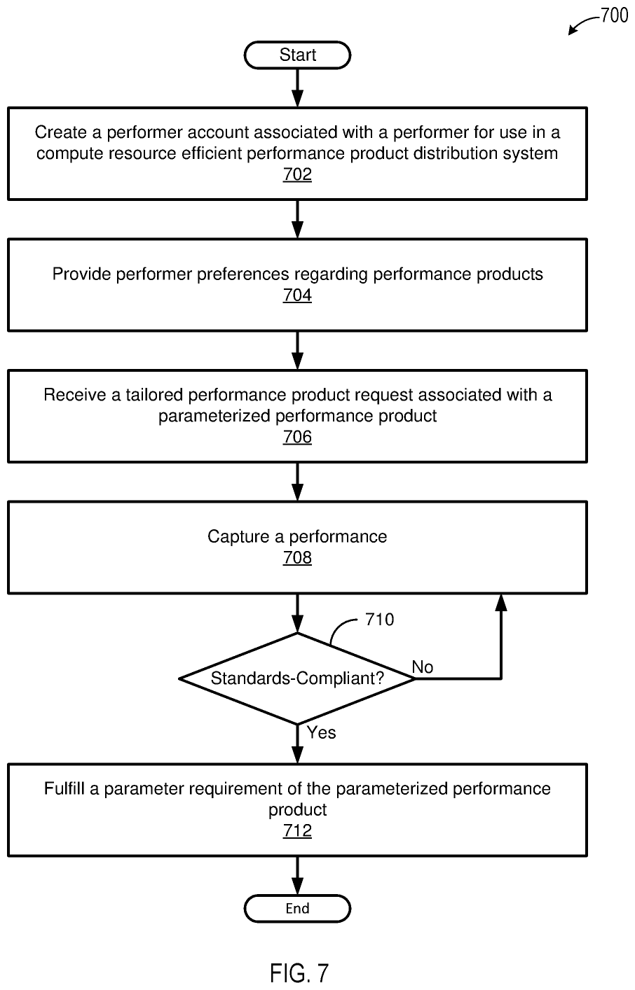

FIG. 7 depicts a flowchart 700 of an example of a method for managing a performer in a compute resource efficient performance product distribution system. The flowchart 700 begins at module 702 with creating a performer account associated with a performer for use in a compute resource efficient performance product distribution system. In this context, “associated with” means a performer can be uniquely identified from the performer account with which the performer is associated. Creating a performer account may involve registration, validation, and verification of the performer at a standards-compliant performance product distribution system. A performer account can include performer preferences (including requirements) related to pricing for performances, tailored performance product requests, self-reported performer characteristics, discovered (i.e., not self-reported) performer characteristics, and financial information that can be used, for example, to accept payment from the performer for performer marketing and/or advertising, performance product leads, performance enhancement tools, or the like and that can be used, for example, to make payment to the performer for performances and advertising revenue attributable to the performer.

The flowchart 700 continues to module 704 with providing performer preferences regarding performance products. Preferences can include tailored performance product request requirements, receiving payment for performances or ad revenue attributable to the performer, making payments for marketing or performance enhancement tools, or the like. Performer preferences can also include marketing preferences, such as content that can be displayed to encourage a prosumer to use the performer, such as a highlight reel of past accomplishments, a previous (or mock) performance of the type that is being requested, or the like.

The flowchart 700 continues to module 706 with receiving a tailored performance product request associated with a parameterized performance product. A performer who receives a tailored performance product request can capture a performance that is responsive to the requirements of the performance parameter. It may or may not be possible to provide a minimally tailored performance that includes pre-captured performances for a variety of recipients. For example, a performer could capture a performance in which they say “Happy Birthday, Shannon!” and then reuse the performance (or take the pre-captured performance from storage for a first time) if a request is made for an intended recipient named Shannon. However, it may be desirable to ensure prosumers get what they expect, so at least a portion of a performance may be required to be captured after receiving a request for a tailored performance product, making the performance product unique, or it could be made clear that minimally tailored performances are possible or selectable (e.g., at a discount relative to a unique performance product).

The flowchart 700 continues to module 708 with capturing a performance. As was indicated in the preceding paragraph, a performance can be minimally tailored by capturing a performance in advance of receiving a tailored performance product request (and, as noted previously, modules can be rearranged in any case). Even in a system that allows minimally tailored performances, a performer will likely capture a performance after receiving a tailored performance product request, making the performance unique. Also as indicated in the preceding paragraph, uniqueness may or may not be a requirement of a specific implementation.

The flowchart 700 continues to decision point 710 where it is determined whether a performance is standards-compliant. Determining whether a performance is standards-compliant can entail checking systemic standards, such as quality control requirements, and product-specific standards, such as requirements a performance be age-appropriate. If it is determined a performance is standards-compliant (710—Yes), the flowchart 700 ends at module 712 with fulfilling a parameter requirement of the parameterized performance product. A performer may or may not have further obligations in accordance with a tailored performance product, such as making a personal appearance, but fulfilling a parameter at least include providing a standards-compliant performance for inclusion in a tailored performance product. If, on the other hand, it is determined a performance is not standards-compliant (710—No), the flowchart returns to module 708 and continues as described previously. A performer may or may not also provide feedback.

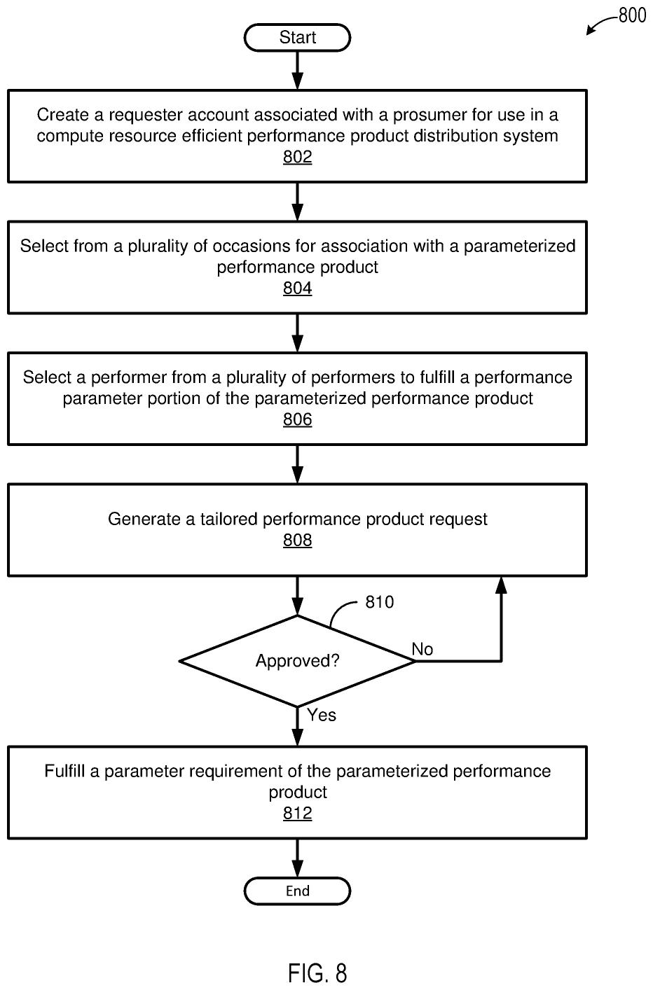

FIG. 8 depicts a flowchart 800 of an example of a method for managing a prosumer in a compute resource efficient performance product distribution system. The flowchart 800 begins at module 802 with creating a requester account associated with a prosumer for use in a compute resource efficient performance product distribution system. In this context, “associated with” means a prosumer, which can comprise one or more persons in addition to the requester, can be uniquely identified from the requester account with which the requester is associated. Creating a requester account may involve registration, validation, and verification of the requester at a standards-compliant performance product distribution system. Compliance for a requester will typically, if done at all, will be related to finances, such as requiring a valid credit card number or the like. Though standards can also related to other issues, such as whether a requester is underage. Also, a questionable payment history, such as a poor credit rating, or questionable behavior, such as evidence of a history of stalking performers, could also trigger non-compliance. A requester account can include requester preferences (including requirements) related to pricing for performances, tailored performance product requests, self-reported requester or recipient characteristics, discovered (i.e., not self-reported) requester characteristics, and financial information that can be used, for example, to make payment to the performer, performance enhancement tools to be used, or the like, and to receive payment for performance product referrals, for example.

The flowchart 800 continues to module 804 with selecting from a plurality of occasions for association with a parameterized performance product. Occasion parameterization is one way in which a performance product distribution system can accomplish compute efficiency. By breaking down occasions into component characteristics and overloading occasion parameters with different occasions, the amount of space necessary to store the performance products is decreased, the bandwidth necessary to send one or more parameters of a performance product is decreased, the ability of a prosumer to tailor a parameterized performance is not impacted, but the dwell time of a performer when responding to a tailored parameterized performance product can be decreased by providing a predictable and minimalist data structure.

The flowchart 800 continues to module 806 with selecting a performer from a plurality of performers to fulfill a performance parameter portion of the parameterized performance product. The performer is responsible for providing a performance that customizes a parameterized performance product for a recipient by saying the recipient's name in the performance, acknowledging the occasion, and/or including some other form of inside information that is uniquely meaningful to the recipient or to a group of which the recipient is a member. In a specific implementation, performers can be found using a search function that allows searching on performer name, performer occupation, performer preferences, performance cost, or the like. Advantageously, because the requester of a performer knows the recipient, a contacts datastore, social network, purchase history, or the like can be used to recommend performers for a requester based upon demographic, geographic, psychographic, and/or behavioristic characteristics of the recipient.

The flowchart 800 continues to module 808 with generating a tailored performance product request. Generating a request can entail creating or updating an entry in a datastore to represent at least the occasion parameters and the performer parameter (though it is conceivable a system could choose a performer for the prosumer using, e.g., a DGPB datastore associated with the intended recipient). For example, a performance product could be sent from a prosumer device datastore (e.g., a buffer) to a remote datastore (e.g., to a performer system, a distribution system, a shared datastore in the cloud, or the like) with instantiated occasion path parameter values in the form of a message or database access request.

The flowchart 800 continues to decision point 810 where it is determined whether a tailored performance product request is approved. The determination as to whether the tailored performance product request is approved can depend upon systemic requirements or performer-specific preferences, pre-performance, or an explicit acceptance of a tailored performance product (e.g., with a performance that can be reviewed by the prosumer), post-performance. If it is determined the tailored performance product request is approved (810—Y), then the flowchart 800 ends at module 812 with fulfilling a parameter requirement of the parameterized performance product. Fulfilling a parameter requirement can include, for example, complying with payment requirements. If, on the other hand, it is determined the tailored performance product is not approved (810—N), then the flowchart 800 returns to module 808 and continues as described previously. Optionally, the prosumer can also provide feedback (not shown).

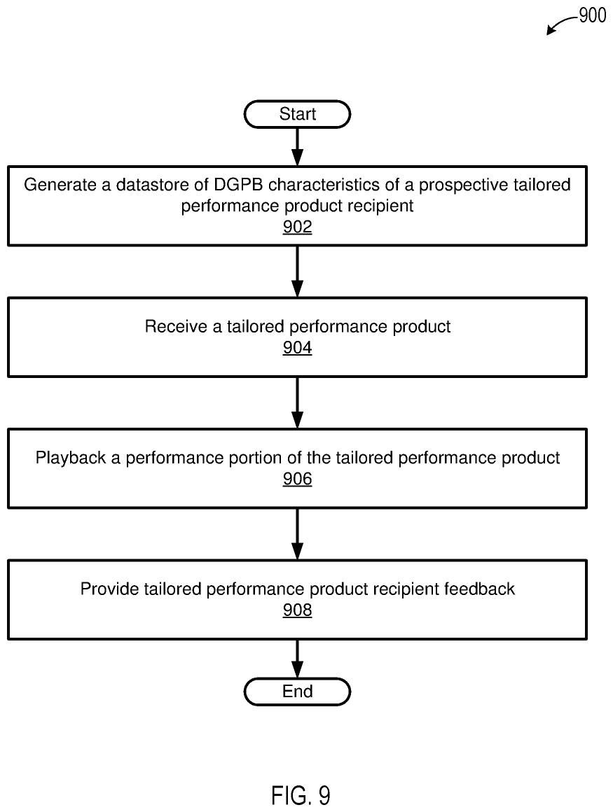

FIG. 9 depicts a flowchart 900 of an example of a method for managing a tailored performance product recipient in a compute resource efficient performance product distribution system. The flowchart 900 begins at module 902 with generating a datastore of demographic, geographic, psychographic, and/or behavioristic (DGPB) characteristics of a prospective tailored performance product recipient. All persons have DGPB characteristics, which can generally be found in public, but cannot always be tied together and specifically associated with a specific individual, particularly an individual who attempts to maintain a level of privacy. However, for a person to be a prospective recipient, at least some characteristics must be known, or a performance product could not be tailored. Accordingly, the DGPB characteristics datastore is presumed to include only data that can be obtained by a prosumer and/or a distribution system, with the understanding more data is probably distributed amongst different datastores across the Internet. Some characteristics may be unknown to the distribution system, such as a name and date of birth of a prosumer's daughter (the intended recipient of a tailored performance product, in this example), but anything that is entered by a prosumer using the prosumer's own personal knowledge is not considered part of the DGPB characteristics datastore, though it may be redundantly represented therein.

The flowchart 900 continues to module 904 with receiving a tailored performance product. A tailored performance product recipient can receive a tailored performance product in a number of different ways, such as by receiving a message with a performance attached, receiving a link that takes the recipient to a performance, or the like. While a digital multimedia performance is assumed in the examples of this paper, instead or in addition, a physical product, such as a DVD (e.g., with a personalized performance), book (e.g., with a personalized poem), or other gift with a degree of personalization can be provided in a manner that is appropriate, such as by receiving the tailored performance product at a physical address via post, a message that the tailored performance product is ready for pickup, or the like. Also, a tailored performance product can have additional deliverable parameters that may or may not include a tailored performance, though they still be matched to the recipient in some way, such as a coupon for Target if the prosumer knows the recipient likes to shop at Target.

The flowchart 900 continues to module 906 with playing back a performance portion of a tailored performance product. Playback can be accomplished with a streaming media player, which can play a file on an end-user device of the recipient or streamed from a location remote relative to the recipient's end-user device.

The flowchart 900 continues to module 908 with providing tailored performance product recipient feedback. Feedback can be made available publicly or privately to one or more parties. For example, feedback, and perhaps a “number of stars” rating, can be listed on a page or area dedicated to a performer (potentially managed by the distribution system to avoid editing by a performer who receives a low ranking). As another example, feedback can be provided to a prosumer in the form of a thank you message, the contents of which are also available to the distribution system.

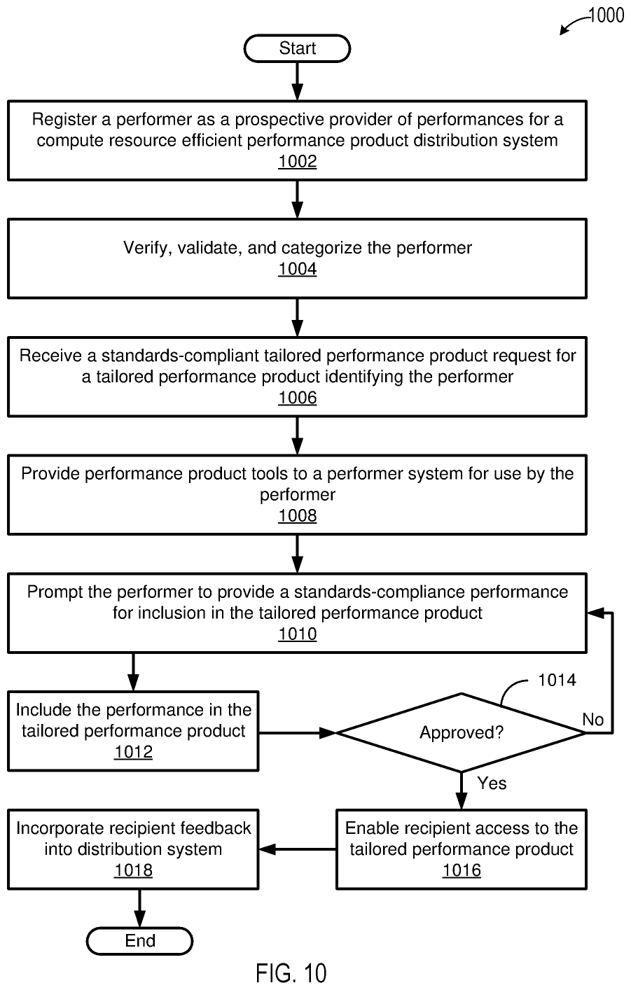

FIG. 10 depicts a flowchart 1000 of an example of a method for managing compute resource efficient performance product distribution. The flowchart 1000 begins at module 1002 with registering a performer as a prospective provider of performances for a compute resource efficient performance product distribution system. Registration typically entails obtaining information about a performer from a registrant to integrate the performer into a distribution system.

The flowchart 1000 continues to module 1004 with validating, verifying, and categorizing a performer. A registrant is validated to ensure the registrant and the performer are one (or at least that the registrant is a human or artificial agent of the performer). A validated registrant is verified to ensure that which the registrant states is true about the performer can be verified. Classification entails assigning the performer to categories and can also entail reclassifying any self-classifications that are determined to be more appropriate within a distribution system. In a specific implementation, performers must also meet systemic standards as part of the vetting process.

The flowchart 1000 continues to module 1006 with receiving a standards-compliant tailored performance product request for a tailored performance product identifying the performer. Tailoring of a performance product typically entails picking a performer to provide a customized multimedia performance for an intended recipient of the tailored performance product. Standards compliance ensures the performer receives requests that meet the standards of the distribution system and, if applicable, that meet their preferences.

The flowchart 1000 continues to module 1008 with providing performance product tools to a performer system for use by the performer. Performer systems may or may not have local performance product enhancement tools that are not provided by the distribution system, but in this example, the performer system receives access to a performance product enhancement datastore (tools) upon registration or sometime thereafter, access to which may or may not be dependent upon tailored performance product parameters.

The flowchart 1000 continues to module 1010 with prompting the performer to provide a standards-compliance performance for inclusion in the tailored performance product. Standards compliance entails meeting parameter requirements of a parameterized performance product and/or meeting systemic standards set by the distribution system.

The flowchart 1000 continues to module 1012 with including the performance in the tailored performance product. A systems compliance check may be done at the distribution system or pushed down to the performer system (though it probably should not be easily modifiable by the performer to avoid compliance). If non-compliant, the performer can be required to recapture a performance. When compliant, the performer or an agent thereof provides the typically multimedia performance to the distribution system when the performer system sends it or uploads to a mutually-accessible datastore.

The flowchart 1000 continues to decision point 1014 with determining whether the performance product is approved by a prosumer. If it is determined the prosumer approves the performance product (1014—Yes), then the flowchart 1000 continues to module 1016 with enabling recipient access to the tailored performance product and ends at module 1018 with incorporating recipient feedback into the distribution system. If, on the other hand, it is determined the prosumer disapproves the performance product (1014—No), then the flowchart 1000 returns to module 1010 and continues as described previously.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A system comprising:
a performance product requester account management engine;
a compute resource efficient performance product tailoring engine coupled to the performance product requester account management engine;
a tailored performance product approval engine coupled to the compute resource efficient performance product tailoring engine;
wherein, in operation, the performance product requester account management engine creates an account on behalf of a requester, the compute resource efficient performance product tailoring engine enhances a performance product template in accordance with tailoring specifications, and the tailored performance product approval engine indicates a tailored performance product has been approved for delivery.

2. The system of claim 1, comprising a requester account datastore coupled to the performance product requester account management engine, wherein the requester account datastore includes the account.

3. The system of claim 1, comprising a parameterized performance product datastore coupled to the performance product requester account management engine, wherein the parameterized performance product datastore includes the performance product template.

4. The system of claim 1, comprising a performer-associated performance product enhancement datastore coupled to the compute resource efficient performance product tailoring engine, wherein the performer-associated performance product enhancement datastore includes at least some of the tailoring specifications.

5. The system of claim 1, comprising an occasion-associated performance product enhancement datastore coupled to the compute resource efficient performance product tailoring engine, wherein the occasion-associated performance product enhancement datastore includes at least some of the tailoring specifications.

6. The system of claim 1, comprising a quantitative performance product enhancement datastore coupled to the compute resource efficient performance product tailoring engine, wherein the quantitative performance product enhancement datastore includes at least some of the tailoring specifications.

7. The system of claim 1, comprising a recipient demographic, geographic, psychographic, and/or behavioristic (DGPB) characteristics datastore coupled to the compute resource efficient performance product tailoring engine, wherein the recipient DGPB characteristics datastore includes at least some of the tailoring specifications.

8. A computer program product including instructions that, when the program is executed by a computer cause the computer to:
manage a performance product requester account, wherein managing includes creating an account on behalf of a requester;
tailor a compute resource efficient performance product, wherein tailoring includes enhancing a performance product template in accordance with tailoring specifications;
approve a tailored performance product, wherein approving includes indicating a tailored performance product has been approved for delivery.

9. The system of claim 8, comprising a requester account datastore coupled to the performance product requester account management engine, wherein the requester account datastore includes the account.

10. The system of claim 8, comprising a parameterized performance product datastore coupled to the performance product requester account management engine, wherein the parameterized performance product datastore includes the performance product template.

11. The system of claim 8, comprising a performer-associated performance product enhancement datastore coupled to the compute resource efficient performance product tailoring engine, wherein the performer-associated performance product enhancement datastore includes at least some of the tailoring specifications.

12. The system of claim 8, comprising an occasion-associated performance product enhancement datastore coupled to the compute resource efficient performance product tailoring engine, wherein the occasion-associated performance product enhancement datastore includes at least some of the tailoring specifications.

13. The system of claim 8, comprising a quantitative performance product enhancement datastore coupled to the compute resource efficient performance product tailoring engine, wherein the quantitative performance product enhancement datastore includes at least some of the tailoring specifications.

14. The system of claim 8, comprising a recipient demographic, geographic, psychographic, and/or behavioristic (DGPB) characteristics datastore coupled to the compute resource efficient performance product tailoring engine, wherein the recipient DGPB characteristics datastore includes at least some of the tailoring specifications.

15. A system comprising:
a means for managing a performance product requester account, including creating an account on behalf of a requester;
a means for tailoring a compute resource efficient performance product coupled to the means for managing a performance product requester account, including enhancing a performance product template in accordance with tailoring specifications;
a means for approving a tailored performance product coupled to the means for tailoring a compute resource efficient performance product, including indicating a tailored performance product has been approved for delivery.

16. The system of claim 15, comprising a requester account datastore coupled to the performance product requester account management engine, wherein the requester account datastore includes the account.

17. The system of claim 15, comprising a parameterized performance product datastore coupled to the performance product requester account management engine, wherein the parameterized performance product datastore includes the performance product template.

18. The system of claim 15, comprising a performer-associated performance product enhancement datastore coupled to the compute resource efficient performance product tailoring engine, wherein the performer-associated performance product enhancement datastore includes at least some of the tailoring specifications.

19. The system of claim 15, comprising an occasion-associated performance product enhancement datastore coupled to the compute resource efficient performance product tailoring engine, wherein the occasion-associated performance product enhancement datastore includes at least some of the tailoring specifications.

20. The system of claim 15, comprising a quantitative performance product enhancement datastore coupled to the compute resource efficient performance product tailoring engine, wherein the quantitative performance product enhancement datastore includes at least some of the tailoring specifications.

21. The system of claim 15, comprising a recipient demographic, geographic, psychographic, and/or behavioristic (DGPB) characteristics datastore coupled to the compute resource efficient performance product tailoring engine, wherein the recipient DGPB characteristics datastore includes at least some of the tailoring specifications.
